(19) United States
(12) Patent Application Publication
(10) Pub. No.: US 2010/0162037 A1
(43) Pub. Date: Jun. 24, 2010

(54) Memory System having Spare Memory Devices Attached to a Local Interface Bus

(75) Inventors: Warren Edward Maule, Cedar Park, TX (US); Kevin C. Gower, LaGrangeville, NY (US); Kenneth Lee Wright, Austin, TX (US)

Correspondence Address: IBM CORPORATION;ROCHESTER IP LAW DEPT. 917, 3605 HIGHWAY 52 NORTH, ROCHESTER, MN, 55901-7829, US

(73) Assignee: International Business Machines Corporation, Armonk, NY (US)

(21) Appl. No.: 12/341,472

(22) Filed: Dec. 22, 2008

(51) Int. Cl. G06F 12/00; G06F 11/20

(52) U.S. Cl. 714/5; 711/154; 714/E11.084; 711/E12.001

(57) ABSTRACT

A memory system includes a memory controller, one or more memory channel(s), and a memory subsystem having a memory interface device (e.g. a hub or buffer device) located on a memory subsystem (e.g. a DIMM) coupled to the memory channel to communicate with the memory device(s) array. This buffered DIMM is provided with one or more spare chips on the DIMM, wherein the data bits sourced from the spare chips are connected to the memory hub device and the bus to the DIMM includes only those data bits used for normal operation. The buffered DIMM with one or more spare chips on the DIMM has the spare memory shared among all the ranks, and the memory hub device includes separate control bus(es) for the spare memory device to allow the spare memory device(s) to be utilized to replace one or more failing bits and/or devices within any rank of memory in the memory subsystem.

### BACKGROUND

Contemporary high performance computing memory systems are generally composed of one or more dynamic random access memory (DRAM) devices, which are connected to one or more processors via one or more memory control elements. Overall computer system performance is affected by each of the key elements of the computer structure, including the performance/structure of the processor(s), any memory cache(s), the input/output (I/O) subsystem(s), the efficiency of the memory control function(s), the main memory device(s), and the type and structure of the memory interconnect interface(s).

Extensive research and development efforts are invested by the industry, to create improved and/or innovative solutions to maximizing overall system performance and density to provide high-availability memory systems/subsystems. High-availability systems present further challenges as related to overall system reliability due to customer expectations that new computer systems will markedly surpass existing systems in regard to mean-time-between-failure (MTBF), in addition to offering additional functions, increased performance, reduced latency, increased storage, lower operating costs. Frequent other customer requirements further exacerbate the memory system design challenges, and these can include such requests as easier upgrades and reduced system environmental impact (such as space, power and cooling).

As computer memory systems increase in performance and density, new challenges continue to arise to in regard to the achievement of system MTBF expectations due to higher memory system data rates and the bit fail rates associated with the data rates. A way for accomplishing the disparate goals of increased memory performance in conjunction with increased reliability and MTBF—without the increasing the memory controller pincount for each of the memory channels, while maintaining and/or increasing the overall memory system high availability and flexibility to accommodate varying customer reliability and MTBF objectives and/or accommodate varying memory subsystem types to allow for such customer objectives as memory re-utilization (e.g. re-use of memory from other computers no longer in use) is required

### SUMMARY

An exemplary embodiment of our invention is provided by a computer memory system that includes a memory controller, one or more memory channel(s), a memory interface device (e.g. a hub or buffer device) located on a memory subsystem (e.g. a DIMM) coupled to the memory channel to communicate with the memory device(s) array (DRAMs) of the memory subsystem.

The memory interface device which we call a hub or buffer device is located on the DIMM in our exemplary embodiment. This buffered DIMM is provided with one or more spare chips on the DIMM, wherein the data bits sourced from the spare chips are connected to the memory hub device and the bus to the DIMM includes only those data bits used for normal operation.

Our buffered DIMM with one or more spare chips on the DIMM has the spare memory shared among all the ranks on the DIMM, and as a result there is a lower fail rate on the DIMM, and a lower cost.

The memory hub device includes separate control bus(es) for the spare memory device to allow the spare memory device(s) to be utilized to replace one or more failing bits and/or devices within any rank of memory in the memory subsystem. Our solution results in a lower cost, higher reliability (as compared to a subsystem with no spares) solution also having lower power dissipation than a solution having one or more spare memory devices for each rank of memory. In an exemplary embodiment, the separate control bus from the hub to the spare memory device includes one or more of a separate and programmable CS (chip select), CKE (clock enable) and other other signal(s) which allow for unique selection and/or power management of the spare device. For more detail More detail on this unique selection and/or power management of the memory devices used in the memory module or DIMM is shown in the application filed concurrently herewith, entitled “Power management of a spare DRAM on a buffered DIMM by issuing a power on/off command to the DRAM device” filed concurrently hereby by inventors Warren Maule et al., and assigned to the assignee of this application, International Business Machines Corporation, which is fully incorporated herein by reference.

In our memory subsystem containing what we call an interface or hub device, memory device(s) and one or more spare memory device(s), the interface or hub device and/or the memory controller can transparently monitor the state of the spare memory device(s) to verify that it is still functioning properly.

Our buffered DIMM may have one or more spare chips on the DIMM, with data bits sourced from the spare chips connected to the memory interface or hub device and the bus to the DIMM includes only those data bits used for normal operation

This memory subsystem including x memory devices comprising y data bits which may be accessed in parallel. The memory devices includes both normally accessed memory devices and spare memory, wherein the normally accessed memory devices have a data width of z where the number of y data bits is greater than the data width of z. The subsystem's hub device is provided with circuitry to redirect one or more bits from the normally accessed memory devices to one or more bits of a spare memory device while maintaining the original interface data width of z.

This memory subsystem with one or more spare chips improves the reliability of the subsystem in a system wherein the one or more spare chips can be placed in a reset state until invoked, thereby reducing overall memory subsystem power .

Furthermore, spare chips can be placed in self refresh and/or another low power state until required to reduce power.

These features of our invention provide an enhanced reliability high-speed computer memory system which includes a memory controller, a memory interface device, memory devices for the storing and retrieval of data and ECC information and which may have provision for spare memory device(s) wherein the spare memory device(s) enable a failing memory device to be replaced and the sparing is completed between the memory interface device and the memory devices. The memory interface device further includes circuitry to change the operating state, utilization of and/or power utilized by the spare memory device(s) such that the memory controller interface width is not increased to accommodate the spare memory device(s).

In an exemplary embodiment the memory controller is coupled via one of either a direct connection or a cascade interconnection through another memory hub device and multiple memory devices included on the memory array subsystem, such as a DIMMs for the storage and retrieval of data and ECC bits which are in communication with the memory controller via one or more cascade interconnected memory hub devices. The DIMM includes memory devices for the storage and retrieval of data and EDC information in addition to one or more “spare” memory device(s) which are not required for normal system operation and which may be normally retained in a low power state while the memory devices storing data and EDC information are in use. The replacement or spare memory device (e.g. a “second” memory device) may be enabled, in response to one or more signals from the interface or hub device, to replace an other (first) memory device originally utilized for the storage and retrieval of data and/or EDC information such that the previously spare memory device operates as a replacement for the first memory device. The memory channel includes a unidirectional downstream bus comprised of multiple bitlanes, one or more spare bit lanes and a downstream clock coupled to the memory controller and operable for transferring data frames with each transfer including multiple bit lanes.

Another exemplary embodiment is a system that includes a memory controller, one or more memory channel(s), a memory interface device (e.g. a hub or buffer device) located on a memory subsystem (e.g. a DIMM) coupled to the memory channel to communicate with the memory controller via one of a direct connection and a cascade interconnection through another memory hub device and multiple memory devices included on the DIMM for the storage and retrieval of data and ECC bits and in communication with the memory controller via one or more cascade interconnected memory hub devices. The hub device includes connections to one or more memory “spare” memory devices which are not required for normal system operation and which may be normally retained in a low power state while the memory devices storing data and EDC information are in use. The spare memory device(s) may be utilized to replace a (first) memory device located on any of the one or more ranks of memory on the one or more DIMMs attached to the hub device may be enabled, in response to one or more signals from the hub device, to replace an other first memory device originally utilized for the storage and retrieval of data and/or EDC information such that the previously spare memory device operates as a replacement for the first memory device. The memory channel includes a unidirectional downstream bus comprised of multiple bitlanes, one or more spare bit lanes and a downstream clock coupled to the memory controller and operable for transferring data frames with each transfer including multiple bit lanes.

Other systems, methods, apparatuses, and/or design structures according to embodiments will be or become apparent to one with skill in the art upon review of the following drawings and detailed description. It is intended that all such additional systems, methods, apparatuses, and/or design structures be included within this description, be within the scope of the present invention, and be protected by the accompanying claims.

### BRIEF DESCRIPTION OF THE SEVERAL VIEWS OF THE DRAWINGS

Referring now to the drawings wherein like elements are numbered alike in the several FIGURES:

FIG. 1 depicts the front and rear views of a memory sub-system in the form of a memory DIMM, which includes a local communication interface hub or buffer device interfacing with multiple memory devices, including spare memory devices, that may be implemented by exemplary embodiments;

FIG. 2 depicts a memory system which includes a memory controller and memory module(s) including local communication interface hub device(s), memory device(s) and spare memory device(s) which communicate by way of the hub device(s) which are cascade-interconnected that may be implemented by exemplary embodiments;

FIG. 3 depicts a memory system which includes a memory controller and memory module(s) including local communication interface hub device(s), memory device(s) and spare memory device(s) which communicate by way of the hub device(s) which are connected to each other and the memory controller using multi-drop bus(es) that may be implemented by exemplary embodiments;

FIG. 4a is a diagram of a memory local communication interface hub device which includes connections to spare memory device(s) that may be implemented by exemplary embodiments;

FIG. 4b is a diagram of the memory local communication interface hub device including further detail of elements that may be implemented in exemplary embodiments;

FIG. 5 is a diagram of an alternate memory local communication interface hub device which includes connections to spare memory device(s) that may be implemented by alternate exemplary embodiments;

FIG. 6 depicts a memory system which includes a memory controller, a memory local communication interface hub device with connections to spare memory device(s) and port(s) which connect the hub device to memory modules, wherein the hub device communicates with the memory controller over separate cascade-interconnected memory buses that may be implemented by exemplary embodiments;

FIG. 7 is a diagram illustrating a local communication interface hub device port which connects to memory devices for the storage of information in addition to connecting to spare memory devices that may be implemented in exemplary embodiments; and

FIG. 8 is a flow diagram of a design process used in semiconductor design, manufacture, and/or test.

FIG. 9 (No FIG. 9 is included at this time);

FIG. 10 (No FIG. 10 is included at this time);

FIG. 11 (No FIG. 11 is included at this time);

FIG. 12 (No FIG. 12 is included at this time);

FIG. 13 (No FIG. 13 is included at this time):

### DETAILED DESCRIPTION

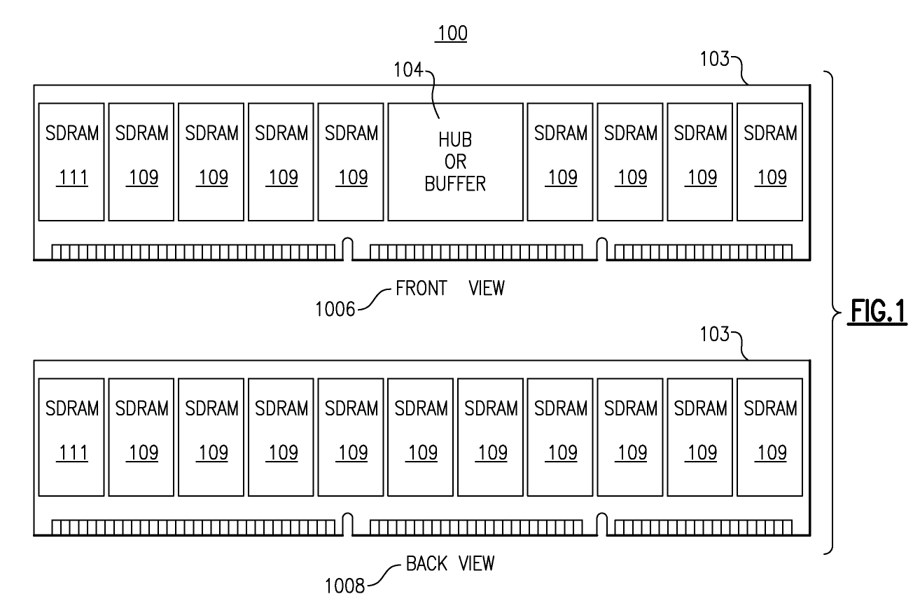

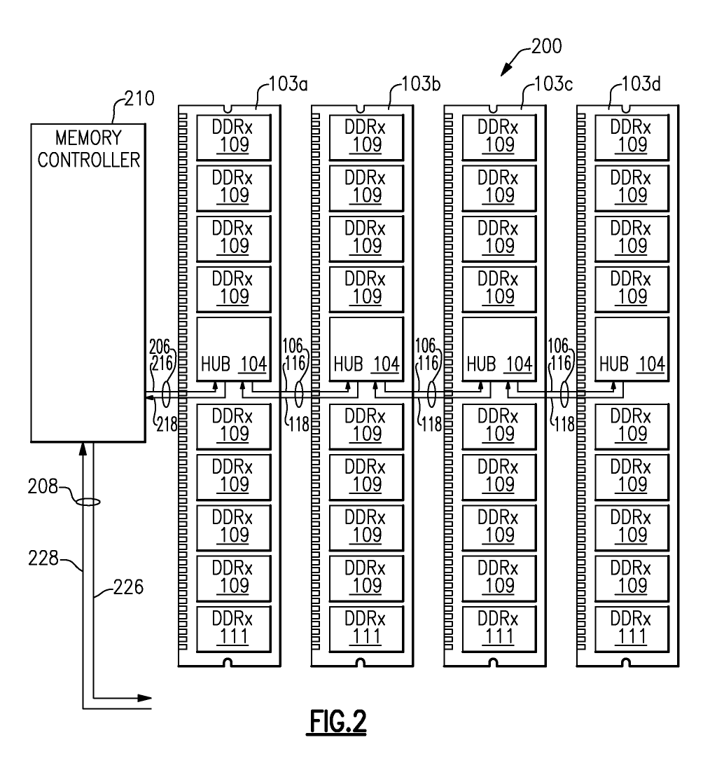

The invention as described herein provides a memory system providing enhanced reliability and MTBF over existing and planned memory systems. Interposing a memory hub and/or buffer device as shown in FIG. 1 as a communication interface device 104 between a memory controller (e.g. 210 in FIG. 2) and memory devices 109 enables a flexible high-speed protocol with error detection to be implemented. The inclusion of spare memory devices 111 connected to the hub and/or buffer device directly and/or through one or more registers or secondary buffers enable the memory system to replace failing memory devices normally used for the storage of data, ECC check bits or other information with spare memory devices which directly and/or indirectly connect to hub and/or buffer device(s). In the exemplary embodiment(s) shown in FIG. 2 and FIG. 3, the memory controller (210, 310) pincount and/or the number of transfers required for normal memory operation over one or more memory controller ports may be the same for memory systems including spare memory device(s) and memory systems which do not include spare memory device(s). The spare memory device(s) are connected to the hub (or buffer) device(s) by way of unique data lines for the spare memory device(s) and may further be connected to the hub by way of one or more of memory address, command and control signals which are separate from similar signals which are required for the storage and retrieval of data from the memory devices which together comprise the data and ECC information required for by the system for normal system operation.

The invention offers further flexibility by including exemplary embodiments for memory systems including hub devices which connect to Unbuffered memory modules (UDIMMs), Registered memory modules (RDIMMs) and/or other memory cards known in the art and/or which may be developed which do not include spare memory device(s) and wherein the spare memory device(s) are closely coupled or attached to the hub device. The spare memory device(s), in conjunction with exemplary connection and/or control means provide for increased system reliability and/or MTBF while retaining the performance and approximate memory controller pincount for systems that do not include spare memory device(s). The invention as described herein provides the inclusion of spare memory devices in systems having memory subsystem(s) in communication with a memory controller over a cascade inter-connected bus, a multi-drop bus or other bus means wherein the spare memory device(s) provide for improved memory system reliability and/or MTBF and memory controller memory interface pincounts associated with memory subsystems that do not include one or more spare memory device(s).

Turning specifically now to FIG. 1 (100), an example of a Dual Inline Memory Module (heretofore described as a “DIMM”) 103 is shown which includes a local communication interface hub or buffer device (heretofore described as a “buffer” or “hub”) 104, memory devices 109 and spare memory devices 111. The front and rear of the DIMM 103 is shown, with a single buffer device 104 shown on the front of the module. In alternate exemplary embodiments, two or more buffer devices 104 may be included on module 103 in addition to more or less memory devices 109 and 111—as determined by such system application requirements as the data width of the memory interface (as provided for by memory devices 109), the DIMM density (e.g. the number of memory “ranks” on the DIMM), the required performance of the memory (which may require additional buffers to reduce loading and permit higher transfer rates) and/or the relative cost and/or available space for these devices. In the exemplary embodiment, DIMM 103 includes eighteen 8 bit wide memory devices 109, comprising two ranks of 72 bits of data to buffer device 104, with each rank of memory being separately selectable. In addition, each memory rank includes a spare memory device (e.g. an 8 bit memory device) 111 which is connected to buffer 104 and can be used by buffer 104 to replace a failing memory device 109 in that rank. Each memory rank can therefore be construed as including 80 bits of data connected to hub device 104, with 72 bits of the 80 bits written to or read from during a normal memory access operation, such as initiated by memory controller (210 as included in FIG. 2 or 310 as included in FIG. 3). Memory devices 109 connect to the buffer device 104 over a memory bus which is comprised of data, command, control and address information. Spare memory devices 111 (two devices are shown although an exemplary module may include one, two or more such devices) are further connected to the buffer 104, utilizing distinct and separate data pins on the buffer. The module may further include separate CKE (clock enable) or other signals from those connecting the buffer to memory devices 109, such as to enable the buffer to place the one or more spare memory device(s) in a low power state prior to replacing a memory device 109. In an exemplary embodiment, each spare memory device includes connection means to the buffer to enable the spare memory device(s) to uniquely be placed in a low power state and/or enabled for write and read operation independent of the power state of memory devices 109. In alternate exemplary embodiments the memory devices 111 may share the same signals utilized for power management of memory devices 109.

Memory device 111 shares the address and selection signals connected to memory device(s) 109, such that, when activated to replace a failing memory device 109, the spare memory device 111 receives the same address and operational signals as other memory devices 109 in the rank having the failing memory device. In another exemplary embodiment, the spare memory device 111 is wired such that separate address and selection information may be sourced by the buffer device, thereby permitting the buffer device 104 to enable the spare memory device 111 to replace a memory device 109 residing in any of two or more ranks on the DIMM. This embodiment requires more pins on the memory buffer and offers greater flexibility in the allocation and use of spare device(s) 111—thereby increasing the reliability and MTBF in cases where a rank of memory includes more failing memory devices 109 than the number of spare devices 111 assigned for use for that memory rank and wherein other unused spare devices 111 exist and are not in use to replace failing memory devices 109. Additional information related to the exemplary buffer 104 interface to memory devices 109 and 111 are discussed hereinafter.

In an exemplary embodiment illustrated in FIG. 2, DIMMs 103a, 103b, 103c and 103d include 276 pins and/or contacts which extend along both sides of one edge of the memory module, with 138 pins on each side of the memory module. The module includes sufficient memory devices 109 (e.g. nine 8-bit devices or eighteen 4-bit devices for each rank) to allow for the storage and retrieval of 72 bits of data and EDC check bits for each address. The exemplary module also includes one or more memory devices 111 which have the same data width and addressing as the memory devices 109, such that a spare memory device 111 may be used by buffer 104 to replace a failing memory device 109. The memory interface between the modules 103 and memory controller 210 transfers read and write data in groups of 72 bits, over one or more transfers, to selected memory devices 109. When a spare memory device is used to replace a failing memory device 109, in the exemplary embodiment, the data is written to both the original (e.g. failing) memory device 109 as well as to the spare device 111 which has been activated by buffer 104 to replace the failing memory device 109. During read operations, the exemplary buffer device reads data from memory devices 109 in addition to the spare memory device 111 and replaces the data from failing memory device 109, by such means as a data multiplexer, with the data from the spare memory device which has been activated by the buffer device to provide the data originally intended to be read from failing memory device 109.

FIG. 3 comprises an alternate exemplary multi-drop bus memory system 300 that includes a memory bus 306 which includes a bi-directional data bus 318 and a bus used to transfer address, command and control information from memory controller 310 to one or more of DIMMs 303a, 303b, 303c and 303d. Additional busses may be included in the interface between memory controller 310 and memory DIMMs 303, passing either from the memory controller 310 to the DIMMs 303 and/or from one or more DIMMs 303 to memory controller 310. Data bus 318 and address bus 316 may also include either signals and/or be operated for other purposes such as error reporting, status requests and responses, bus initialization, testing, etc, without departing from the teachings herein. In

FIG. 3, data and address buses 318 and 316 respectively connect memory controller 310 to one or more memory modules 303 in a multi-drop nature—e.g. without re-driving signals from a first DIMM 303 (e.g. DIMM 303a) to a second DIMM 303 (e.g. DIMM 303b) or from a first DIMM 303 (e.g. DIMM 303a) to memory controller 310. To achieve high data rates, the exemplary DIMMs 303 include a buffer device which re-drives data, address, command and control information associated with accesses to memory devices 109 (and/or when activated, to one or more memory devices 111), thereby minimizing the loading on buses 318 and 316. Exemplary DIMMs 303 further include minimized trace lengths from the contacts 320 to the buffer device 104, such that a minimum stub length exists at each DIMM position. With the use of buffer 304 in conjunction with minimized trace lengths between the contacts 320 and buffer 304, high transfer rates can be achieved between memory controller 310 and DIMMs 303x.

Exemplary DIMMs 303a-d are similar to DIMMs 103a-d, differing primarily in the bus structures utilized to transfer such information as address, controls, commands and data between the DIMMs and the memory controllers (310 and 210 respectively for FIG. 3 and FIG. 2) and the interface of the buffer device that connects to other DIMMs and/or the memory controller. In the exemplary memory structure shown in FIG. 3, memory bus 306 is a parallel bus consistent with that of memory devices 109 and 111 on DIMMs 303a-d. Information transferred over the memory bus 306 operates at the same frequency as the information transferred between the buffer device and memory devices 109 and 111, with memory accesses initiated by the memory controller 310 being executed in a manner consistent with that of the memory devices (e.g. DDR3 memory devices) 109 and 111, with the buffer device 304 including circuitry to re-drive signals traveling to and from the memory devices 109 and/or 111 with minimal delay relative to a memory clock also received and re-driven, in the exemplary embodiment, by buffer 304. As with DIMMs 103a-d in the cascade interconnect memory 200, the DIMMs in multi-drop memory system 300 receive an information stream from the memory controller 310 which can include of a mixture of commands and data to be selectively stored in the memory devices 109 included on any one or more of DIMMs 303a-d, and in the exemplary embodiment, also include EDC “check bits” which are generated by the memory controller with respect to the data to be stored in memory devices 109, and stored in memory devices 109 in addition to the data during write operations. During read operations initiated by the memory controller 310, data (and EDC information, if applicable) stored in memory devices 109 is sent to the memory controller via buffer 304, on the multi-drop interconnection data bus 318. The memory controller 310 receives the data and any EDC check bits. In read operations which return both data and EDC check bits, the memory controller compares the received data to the EDC check bits, using methods and algorithms known in the art, to determine if one or more memory bits and/or check bits are incorrect.

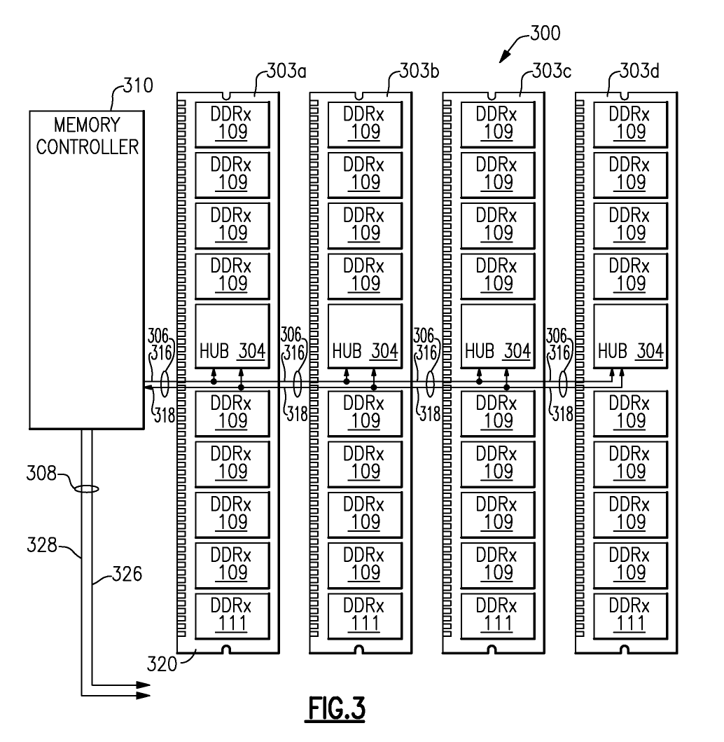

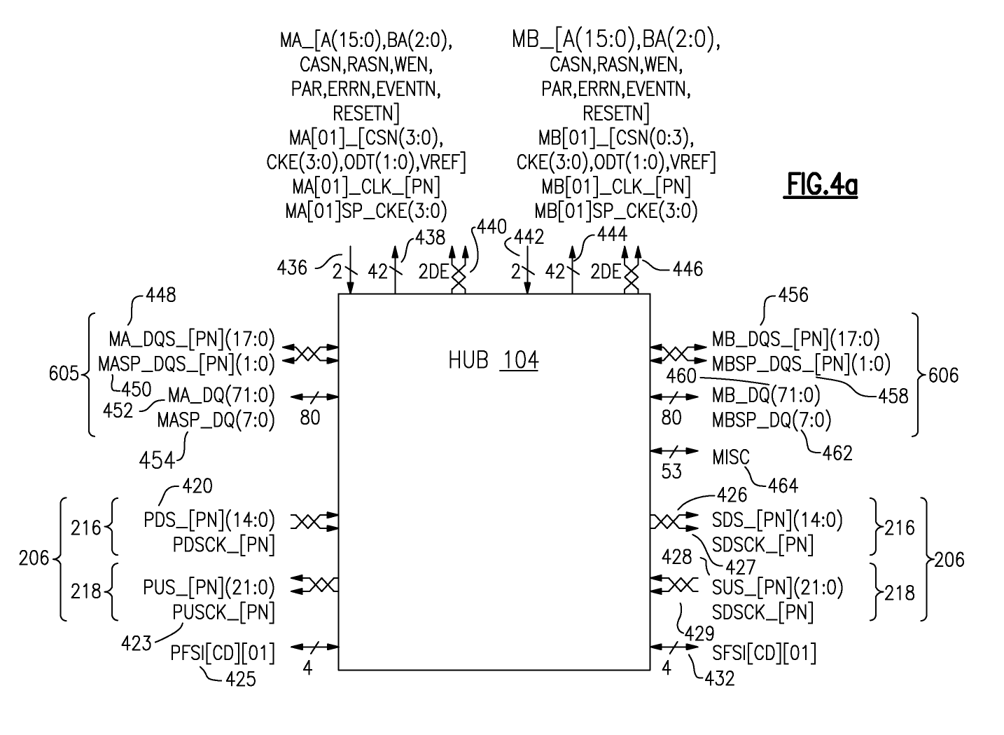

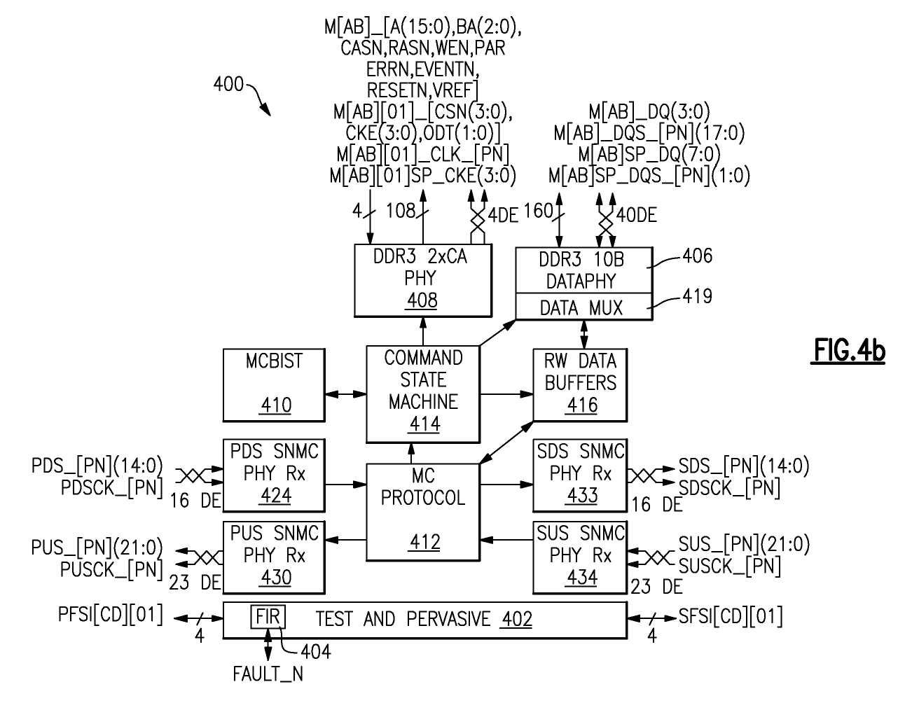

As in FIG. 2, commands and data in FIG. 3 can be initiated by the memory controller 310 in response to instructions received from a host processing system, such as from one or more processors and cache memory. The memory buffer device 304 can also include additional communication interfaces, for instance, a service interface to initiate special test modes of operation that may assist in configuring and testing the memory buffer device 304. Buffer device 304 may also initiate memory write, read, refresh, power management and other operations to memory devices 109 and 111 either in response to instructions from memory controller 310, a service interface or from circuitry within the buffer device such as MCBIST circuitry (e.g. MCBIST circuitry such as in block 410 in FIG. 4b, with such circuitry modified, as known in the art, to communicate with memory controller 310 over a multi-drop bus 306).

As in memory system 200 in FIG. 2, memory device 111 shares the address and selection signals connected to memory device(s) 109, such that, when activated to replace a failing memory device 109, the spare memory device 111 receives the same address and operational signals as other memory devices 109 in the rank having the failing memory device. In another exemplary embodiment, the spare memory device 111 is wired such that separate address and selection information may be sourced by the buffer device, thereby permitting the buffer device 304 to enable the spare memory device 111 to replace a memory device 109 residing in any of two or more ranks on the DIMM. This embodiment requires more pins on the memory buffer and offers greater flexibility in the allocation and use of spare device(s) 111—thereby increasing the reliability and MTBF in cases where a rank of memory includes more failing memory devices 109 than the number of spare devices 111 assigned for use for that memory rank and wherein other unused spare devices 111 exist and are not in use to replace failing memory devices 109. Additional information related to the exemplary buffer 304 interface to memory devices 109 and 111 are included later.

In an exemplary embodiment, DIMMs 303a, 303b, 303c and 303d include 276 pins and/or contacts which extend along both sides of one edge of the memory module, with 138 pins on each side of the memory module. The module includes sufficient memory devices 109 (e.g. nine 8-bit devices or eighteen 4-bit devices for each rank) to allow for the storage and retrieval of 72 bits of data and EDC check bits for each address. The exemplary modules 303a-d also include one or more memory devices 111 which have the same data width and addressing as the memory devices 109, such that a spare memory device 111 may be used by buffer 304 to replace a failing memory device 109. The memory interface between the modules 303a-d and memory controller 310 transfers read and write data in groups of 72 bits, over one or more transfers, to selected memory devices 109. When a spare memory device is used to replace a failing memory device 109, in the exemplary embodiment, the data is written to both the original (e.g. failing) memory device 109 as well as to the spare device 111 which has been activated by buffer 304 to replace the failing memory device 109. During read operations, the exemplary buffer device reads data from memory devices 109 in addition to the spare memory device 111 and replaces the data from failing memory device 109, by such means as a data multiplexer, with the data from the spare memory device which has been activated by the buffer device to provide the data originally intended to be read from failing memory device 109. Alternate exemplary DIMM embodiments may include 200 pins, 240 pins or other pincounts and may have normal data widths of 64 bits, 80 bits or data widths depending on the system requirements. More than one spare memory device 111 may exist on DIMMs 303a-d, with exemplary embodiments including at least one memory device 111 per rank or one memory device(s) 111 per 2 or more ranks wherein the spare memory device(s) can be utilized, by buffer 304, to replace any of the memory devices 109 that include fails in excess of a pre-determined limit established by one or more of the buffer 304, memory controller 310, a processor (not shown), a service processor (not shown).

FIG. 4 includes a summary of the signals and signal groups that are included on an exemplary buffer or hub 104, such as the buffer included on exemplary DIMMs 103a-d. Signal group 420 is comprised of true and complement (e.g. differential) primary downstream link signals traveling away from memory controller 210. In the exemplary embodiment, 15 differential signals are included, identified as PDS_[PN](14:0) where “PDS” is defined as “primary downstream bus (or link) signals”, “PN” is defined as “positive and negative”—indicating that the signal is a differential signal and “14:0” indicates that the bus has 15 signal pairs (since the signal is a differential signal) numbering from 0 to 14. Other signal names in FIG. 4a have similar naming conventions to describe such attributes as the pin and/or pin group function, signal polarity (e.g. positive active, negative active or positive and/or negative active such as with differential signaling) and pincount. Continuing with FIG. 4a, signal pair 421 is a forwarded differential clock which travels with signals comprising signal group 420, with the differential clock 421 used for the capture of primary downstream bus signals 420. Signal group 426 is comprised of true and complement (e.g. differential) secondary (e.g. re-driven) downstream link signals traveling away from memory controller 210. In the exemplary embodiment, 15 differential signals are included, matching the number of primary downstream signals 420, identified as SDS_[PN](14:0) where “SDS” is defined as “secondary downstream bus (or link) signals”. Signal pair 427 is the forwarded differential clock which travels with signals comprising signal group 426, with the differential clock 427 used for the capture of secondary downstream bus signals 426 at the next buffer device in the cascade interconnect structure.

Continuing on with FIG. 4a, the signal group 428 is comprised of differential secondary upstream link signals traveling toward memory controller 210. Signal pair 429 is the forwarded differential clock which travels with the signals comprising signal group 428, with the differential clock 429 used for the capture of the secondary upstream bus signals 428 at hub device 104. Signal group 425 is comprised of FSI and/or JTAG (e.g. test interface) signals which may be used for such purposes as error reporting, status requests, status reporting, buffer initialization. This bus typically operates at a much slower frequency than that of the memory bus, and thereby requires minimal if any training prior to enabling communication between connected devices. As a “primary” signal group, the signals are used for communication between the current device and an upstream device (e.g. in the direction toward the memory controller). Signal group 432 is the secondary (e.g. re-driven) FSI and/or JTAG signal group for connection to buffer devices located further from the memory controller. Note that upstream and downstream signals may be acted upon by a receiving hub device and not simply re-driven, with the information in a received signal group modified in many cases to include additional and/or different information, be-re-timed to reduce accumulated jitter. Signal group 452 is comprised of the 72 bit memory bi-directional data interface signals to memory devices 109 attached to one of two ports (e.g. port “A”) of the exemplary 2-port memory buffer device. The signals comprising 454 are also memory bi-directional data interface signals attached to port A, wherein these data signals (numbering 8 data signals in the exemplary embodiment) connect to the data pins of spare memory device(s) 111, thereby permitting the buffer device to uniquely access these data signals. Port B memory data signals are similarly comprised of 72 bidirectional data interface signals 460 and spare bidirectional memory interface signals which connect to memory devices 109 and 111 which are connected by way of these data signals to port B. Signal groups 448 and 450 comprise DQS (Data Query Strobe) signals connecting to port A memory devices 109 and 111 respectively. Similarly, signal groups 456 and 458 comprise DQS (Data Query Strobe) signals connecting to port B memory devices 109 and 111 respectively. Signal groups 448, 450, 452 and 454 comprise the data bus and data strobes 605 to memory devices and spare memory devices connected to port A (in the exemplary embodiment, numbering 80 data bits and 20 differential data strobes in total), wherein 72 of the 80 data bits from port A are transferred to the memory controller during a normal read operation. As with port A, in the exemplary embodiment signal groups 456, 458, 460 and 462 comprise the data bus and data strobes 606 to memory devices and spare memory devices connected to port B (in the exemplary embodiment, numbering 80 data bits and 20 differential data strobes in total), wherein 72 of the 80 data bits from port B are transferred to the memory controller during a normal read operation.

Control, command, address and clock signals to memory devices having data bits connected to port A are shown as signal groups 436, 438 and 440, while control, command, address and clock signals to memory devices having data bits connected to port B are shown as signal groups 442, 444 and 446. In an exemplary embodiment, control, command and address signals other than CKE signals are connected to memory devices 109 and 111 attached to ports A and ports B, as indicated in the naming of these signals. As evidenced by the naming a signal count for chip selects (e.g. CSN(0:3)), the exemplary buffer device can separately access 4 ranks of memory devices, whereas contemporary buffer devices include support for only 2 memory ranks. Other signal groupings such as CKE (with 4 signals (e.g. 3:0) per port) ODT (with 2 signals (e.g. 1:0) per port) are also used to permit unique control for one rank of 4 possible ranks (e.g. for signals including the text “3:0”) or in the case of ODT, can control unique ranks when one or two ranks exist on the DIMM or 2 of 4 ranks when 4 ranks of memory exist on the DIMM (e.g. as shown by the text “1:0” in the signal name). Note that this exemplary embodiment includes 4 unique CKE signals (e.g. 3:0) for the control of spare memory device(s) 111 attached to port A and port B. The use of separate CKE signals permit the buffer device 104 to control the power state of the memory devices 111 independent of and/or simultaneous with control of the power state of memory devices 109. In an exemplary embodiment, spare memory devices 111 are placed in a low power state (e.g. self-refresh, reset, etc) when not in use. If one of the one or more spare memory device(s) 111 on a given module is activated and used to replace a failing memory device 109, that spare memory device may be uniquely removed from the low power state consistent with the memory device specification, using the unique CKE signal connected from the buffer 104 to that memory device 111. Although data (e.g. 454 and/or 462), data strobe (e.g. 450 and/or 458) and CKE (included within signal groups 438 and/or 444) are shown as being the only signals that interface solely with spare memory devices 111, other exemplary embodiments may include additional unique signals to the spare memory devices 111 to permit additional unique control of the spare memory devices 111. The very small loading presented by the spare memory devices 111 to the memory interface buses for ports A and B permits the signals and clocks included in these buses to attach to both the memory devices 109 and spare memory devices 111, with minimal, if any, affect on signal integrity and the maximum operating speed of these signals—whether the spare memory devices 111 are in an active state or a low power state.

Further information regarding the operation of exemplary cascade interconnect buffer 104 is described herein, relating to FIG. 4b. FIG. 4b depicts a block diagram of an embodiment of memory buffer or hub device 104 that includes a command state machine 414 coupled to read/write (RW) data buffers 416, a DDR3 command and address physical interface supporting two ports (DDR3 2xCA PHY) 408, a DDR3 data physical interface supporting two 10-byte ports (DDR3 2x10B Data PHY) 406, a data multiplexor, controlled by command state machine 414 to establish data communication with memory devices 109 and one or more spare memory devices 111 (e.g. when sparing is invoked to one or more memory devices 111, in one or more of various test modes and/or diagnostic modes which may test a portion and/or all of the memory devices 109 and 111 and/or shadowing modes (e.g. when data is sent to memory devices 109 and data directed to a memory device 109 is “shadowed” with a spare memory device 111 (e.g. written to both a memory device 109 and a memory device 11), a memory control (MC) protocol block 412, and a memory card built-in self test engine (MCBIST) 410. The MCBIST 410 provides the capability to read/write different types of data patterns to specified memory locations (including, in the exemplary embodiment, memory locations within spare memory devices 111) for the purpose of detecting memory device faults that are common in memory subsystems. The command state machine 414 translates and interprets commands received from the MC protocol block 412 and the MCBIST 410 and may perform functions as previously described in reference to the controller interfaces 206 and 208 of FIG. 2 and the memory buffer interfaces of FIG. 4a. The RW data buffers 416 include circuitry to buffer read and write data under the control of command state machine 414. The MC protocol block 412 interfaces to PDS Rx 424, SDS Tx 428, PUS Tx 430, and SUS Rx 434, with the functionality as previously described in FIG. 4a. The MC protocol block 412 interfaces with the RW data buffers 416, enabling the transfer of read and write data from RW buffers 416 to one or more upstream and downstream buses depending on the current operation (e.g. read and write operations initiated by memory controller 210, MCBIST 410 and/or an other buffer device 104, etc). Additionally, a test and pervasive block 402 interfaces with primary FSI clock and data (PFSI[CD][01]) and secondary (daisy chained) FSI clock and data (SFSI[CD][01]) as an embodiment of the service interface 124 of FIG. 1. In an alternate embodiment, which may included as an additional mode of operation supported by the same buffer 104, test and pervasive block 402 may be programmed to operate as a JTAG-compatible device wherein JTAG signals may be received, acted upon and/or re-driven via the test and pervasive block 402. Test and pervasive block 402 may include a FIR block 404, used for such purposes as the reporting of error information (e.g. FAULT_N).

In the exemplary embodiment, inputs to the PDS Rx 424 include true and compliment primary downstream link signals (PDS_[PN](14:0)) and clock signals (PDSCK_[PN]). Outputs of the SDS Tx 428 include true and compliment secondary downstream link signals (SDS_[PN](14:0)) and clock signals (SDSCK_[PN]). Outputs of the PUS Tx 430 include true and compliment primary upstream link signals (SUS_[PN](21:0)) and clock signals (SUSCK_[PN]). Inputs to the SUS Rx 434 include true and compliment secondary upstream link signals (PUS_[PN](21:0)) and clock signals (SUSCK_[PN]).

The DDR3 2xCA PHY 408 and the DDR3 2x10B Data PHY 406 provide command, address and data physical interfaces for DDR3 for 2 ports, wherein the data ports include a 64 bit data interface, an 8 bit EDC interface and an 8 bit spare (e.g. data and/or EDC) interface—totaling 80 bits (also referred to as 10B (10 bytes)). The DDR3 2xCA PHY 408 includes memory port A and B address/command/error signals (M[AB]_[A(15:0), BA(2:0), CASN, RASN, RESETN, WEN, PAR, ERRN, EVENTN]), memory IO DQ voltage reference (VREF), memory control signals (M[AB][01]_[CSN(3:0), CKE(3:0), ODT(1:0)]), memory clock differential signals (M[AB][01]_CLK_[PN]), and spare memory CKE control signals M[AB][01]SP_CKE(3:0). The DDR3 2x10B Data PHY 406 includes memory port A and B data signals (M[AB]_DQ(71:0)), memory port A and B spare data signals (M[AB]_SPDQ(7:0)), memory port A and B data query strobe differential signals (M[AB]_DQS_[PN](17:0)) and memory port A and B data query strobe differential signals for spare memory devices 111 (M[AB]_DQS_[PN](1:0)).

To support a variety of memories, such as DDR, DDR2, DDR3, DDR3+, DDR4, and the like, the memory hub device 104 may output one or more variable voltage rails and reference voltages that are compatible with each type of memory device, e.g., M[AB][01]_VREF. Calibration resistors can be used to set variable driver impedance, slew rate and termination resistance for interfacing between the memory hub device 104 and memory devices 109 and 111.

In an exemplary embodiment, the memory hub device 104 uses scrambled data patterns to achieve transition density to maintain a bit-lock. Bits are switching pseudo-randomly, whereby ‘1’ to ‘0’ and ‘0’ to ‘1’ transitions are provided even during extended idle times on a memory channel, e.g., memory channel 206, 208, 306 and 308. The scrambling patterns may be generated using a 23-bit pseudo-random bit sequencer. The scrambled sequence can be used as part of a link training sequence to establish and configure communication between the memory controller 110 and one or more memory hub devices 104.

In an exemplary embodiment, the memory hub device 104 provides a variety of power saving features. The command state machine 414 and/or the test and pervasive block 402 can receive and respond to clocking configuration commands that may program clock domains within the memory hub device 104 or clocks driven externally via the DDR3 2xCA PHY 408. Static power reduction is achieved by programming clock domains to turn off, or doze, when they are not needed. Power saving configurations can be stored in initialization files, which may be held in non-volatile memory. Dynamic power reduction is achieved using clock gating logic distributed within the memory hub device 104. When the memory hub device 104 detects that clocks are not needed within a gated domain, they are turned off. In an exemplary embodiment, clock gating logic that knows when a clock domain can be safely turned off is the same logic decoding commands and performing work associated with individual macros. For example, a configuration register inside of the command state machine 414 constantly monitors command decodes for a configuration register load command. On cycles when the decode is not present, the configuration register may shut off the clocks to its data latches, thereby saving power. Only the decode portion of the macro circuitry runs all the time and controls the clock gating of the other macro circuitry.

The memory buffer device 104 may be configured in multiple low power operation modes. For example, an exemplary low power mode gates off many running clock domains within memory buffer device 104 to reduce power. Before entering the exemplary low power mode, the memory controller 110 can command that the memory devices 109 and/or 111 (e.g. via CKE control signals CKE(3:0) and/or CKE control signals SP_CKE(3:0)) be placed into self refresh mode such that data is retained in the memory devices in which data has been stored for later possible retrieval. The memory hub device 104 may also shut off the memory device clocks (e.g., (M[AB][01]_CLK_[PN])) and leave minimum internal clocks running to maintain memory channel bit lock, PLL lock, and to decode a maintenance command to exit the low power mode. Maintenance commands can be used to enter and exit the low power mode as received at the command state machine 414. Alternately, the test and pervasive block 402 can be used to enter and exit the low power mode. While in the exemplary low power mode, the memory buffer device 104 can process service interface instructions, such as scan communication (SCOM) operations.

An exemplary memory hub device 104 supports mixing of both x4 (4-bit) and x8 (8-bit) DDR3 SDRAM devices on the same data port. Configuration bits indicate the device width associated with each rank (CS) of memory. All data strobes can be used when accessing ranks with x4 devices, while half of the data strobes are used when accessing ranks with x8 devices. An example of specific data bits that can be matched with specific data strobes is shown in table 1.

TABLE 1
Data Bit to Data Strobe Matching

Data Strobe per device width

| Data Bits | x4 | x8 |
|---|---|---|
| ma_dq(0:3) | ma_dqs[pn](0) | Ma_dqs[pn](0) |
| ma_dq(4:7) | ma_dqs[pn](9) | Ma_dqs[pn](0) |
| ma_dq(8:11) | ma_dqs[pn](1) | Ma_dqs[pn](1) |
| Ma_dq(12:15) | ma_dqs[pn](10) | Ma_dqs[pn](1) |
| Ma_dq(16:19) | ma_dqs[pn](2) | Ma_dqs[pn](2) |
| Ma_dq(20:23) | ma_dqs[pn](11) | Ma_dqs[pn](2) |
| Ma_dq(24:27) | ma_dqs[pn](3) | Ma_dqs[pn](3) |
| Ma_dq(28:31) | ma_dqs[pn](12) | Ma_dqs[pn](3) |
| Ma_dq(32:35) | ma_dqs[pn](4) | Ma_dqs[pn](4) |
| Ma_dq(36:39) | ma_dqs[pn](13) | Ma_dqs[pn](4) |
| Ma_dq(40:43) | ma_dqs[pn](5) | Ma_dqs[pn](5) |
| Ma_dq(44:47) | ma_dqs[pn](14) | Ma_dqs[pn](5) |
| Ma_dq(48:51) | ma_dqs[pn](6) | Ma_dqs[pn](6) |
| Ma_dq(52:55) | ma_dqs[pn](15) | Ma_dqs[pn](6) |
| Ma_dq(56:59) | ma_dqs[pn](7) | Ma_dqs[pn](7) |
| Ma_dq(60:63) | ma_dqs[pn](16) | Ma_dqs[pn](7) |
| Ma_dq(64:67) | ma_dqs[pn](8) | Ma_dqs[pn](8) |
| Ma_dq(68:71) | ma_dqs[pn](17) | Ma_dqs[pn](8) |
| mb_dq(0:3) | mb_dqs[pn](0) | mb_dqs[pn](0) |
| mb_dq(4:7) | mb_dqs[pn](9) | mb_dqs[pn](0) |
| mb_dq(8:11) | mb_dqs[pn](1) | mb_dqs[pn](1) |
| mb_dq(12:15) | mb_dqs[pn](10) | mb_dqs[pn](1) |
| mb_dq(16:19) | mb_dqs[pn](2) | mb_dqs[pn](2) |
| mb_dq(20:23) | mb_dqs[pn](11) | mb_dqs[pn](2) |
| mb_dq(24:27) | mb_dqs[pn](3) | mb_dqs[pn](3) |
| mb_dq(28:31) | mb_dqs[pn](12) | mb_dqs[pn](3) |
| mb_dq(32:35) | mb_dqs[pn](4) | mb_dqs[pn](4) |
| mb_dq(36:39) | mb_dqs[pn](13) | mb_dqs[pn](4) |
| mb_dq(40:43) | mb_dqs[pn](5) | mb_dqs[pn](5) |
| mb_dq(44:47) | mb_dqs[pn](14) | mb_dqs[pn](5) |
| mb_dq(48:51) | mb_dqs[pn](6) | mb_dqs[pn](6) |
| mb_dq(52:55) | mb_dqs[pn](15) | mb_dqs[pn](6) |
| mb_dq(56:59) | mb_dqs[pn](7) | mb_dqs[pn](7) |
| mb_dq(60:63) | mb_dqs[pn](16) | mb_dqs[pn](7) |
| mb_dq(64:67) | mb_dqs[pn](8) | mb_dqs[pn](8) |
| mb_dq(68:71) | mb_dqs[pn](17) | mb_dqs[pn](8) |

In an exemplary embodiment, spare memory devices 111 are 8 bit memory devices, with buffer device 104 providing a single CKE to each of up to 4 spare memory devices per port (e.g. using signals M[AB][01]SP_CKE(3:0)). In alternate exemplary embodiments, spare memory devices may be 4 or 8 bit memory devices, with one, two or more spare memory devices per rank and/or one, two or more spare memory devices per memory DIMM (e.g. DIMM 103a-d or DIMM 303a-d), where in the latter case the spare memory device(s) 111 also receive one or more of unique control, command and address signals in addition to unique data signals from hub 104 or 304 such that the one or more spare memory device(s) 111 may be directed (e.g. via command state machine 414, 514 and, associated data PHYs, associated CA PHYs R/W buffers and/or data multiplexers to replace a failing memory device 109 located in any of the memory ranks attached to the port A and/or port B.

Data strobe actions taken by the memory hub device 104 are a function of both the device width and command. For example, data strobes can latch read data using DQS mapping in table 1 for reads from x4 memory devices. The data strobes may also latch read data using DQS mapping in table 1 for reads from ×8 memory devices, with unused strobes gated and on-die termination blocked on unused strobe receivers. Data strobes are toggled on strobe drivers for writing to x4 memory devices, while strobe receivers are gated. For writes to x8 memory devices, strobes can be toggled per table 1, leaving unused strobe drivers in high impedance and gating all strobe receivers. For no-operations (NOPs) all strobe drivers are set to high impedance and all strobe receivers are gated.

CKE to CS mapping is shown in FIG. 2, as related to memory modules comprising x8 memory devices. The rank enable configuration also indicates the mapping of ranks (e.g. CSN), to CKE (e.g. CKE(3:0)) signals. This information is used to track the ‘Power Down’ and ‘Self Refresh’ status of each memory rank as ‘refresh’ and ‘CKE control’ commands are processed. Each of the four buffer 104 control ports will have 0, 1, 2 or 4 memory ranks populated. Invalid commands issued to ranks in the reset state may be reported in the FIR bits. The association of CKE control signals to CS (e.g. rank) depends on the CKE mode and the number of ranks. Invalid commands issued to ranks in the reset state may be reported in the FIR bits. The following table describes the CKE control signals to CS (e.g. rank) association:

TABLE 2
CKE to CS Mapping

| 8 CKE Control Port [ab][01] Rank Enable Decode | | | 16 CKE Control Port [ab][01] Rank Enable Decod [symbol] | | |
|---|---|---|---|---|---|
| RE | Ranks | Enabled chip selects and mapped CKEs | RE | Ranks | Enabled chip selects and mapped C [symbol] |
| ‘00’b | 0 | None | ‘00’b | 0 | None |
| ‘01’b | 1 | m[ab][01]_csn(0) <-> m[ab][01]_cke(0) | ‘01’b | 1 | m[ab][01]_csn(0) <-> m[ab][01]_cke(0) |
| ‘10’b | 2 | m[ab][01]_csn(0) <-> m[ab][01]_cke(0) | ‘10’b | 2 | m[ab][01]_csn(0) <-> m[ab][01]_cke(0) |
| | | m[ab][01]_csn(1) <-> m[ab][01]_cke(1) | | | m[ab][01]_csn(1) <-> m[ab][01]_cke(1) |
| ‘11’b | 4 | m[ab][01]_csn(0,2) <-> m[ab][01]_cke(0) | ‘11’b | 4 | m[ab][01]_csn(0) <-> m[ab][01]_cke(0) |
| | | m[ab][01]_csn(1,3) <-> m[ab][01]_cke(1) | | | m[ab][01]_csn(1) <-> m[ab][01]_cke(1) |
| | | | | | m[ab][01]_csn(2) <-> m[ab][01]_cke(2) |
| | | | | | m[ab][01]_csn(3) <-> m[ab][01]_cke(3) |

[symbol]

indicates data missing or illegible when filed

In an exemplary embodiment, memory hub device 104 supports a 2N, or 2T, addressing mode that holds memory command signals valid for two memory clock cycles and delays the memory chip select signals by one memory clock cycle. The 2N addressing mode can be used for memory command busses that are so heavily loaded that they cannot meet memory device timing requirements for command/address setup and hold. The memory controller 110 is made aware of the extended address/command timing to ensure that there are no collisions on the memory interfaces. Also, because chip selects to the memory devices are delayed by one cycle, some other configuration register changes may be performed in this mode.

In order to reduce power dissipated by the memory hub device 104, a ‘return to High-Z’ mode is supported for the memory command busses. Memory command busses, e.g., address and control busses 438 and 444 of FIG. 4a, can include the following signals: M[AB]_A(15:0), M[AB]_RASN, CASN, WEN, etc]. When the return to High-Z mode is activated, memory command signals go into the high impedance (High-Z) state during memory device deselect command decodes.

During DDR3 read and write operations, the memory hub device 104 can activate DDR3 on-die termination (ODT) control signals, M[AB][01]_ODT(1:0) for a configured window of time. The specific signals activated are a function of read/write command, rank and configuration. In an exemplary embodiment, each of the ODT control signals has 16 configuration bits controlling its activation for reads and write to the ranks within the same DDR3 port. When a read or write command is performed, ODTs may be activated if the configuration bit for the selected rank is enabled. This enables a very flexible ODT capability in order to allow memory device 109 and/or 111 configurations to be controlled in an optimized manner. Memory systems that support mixed x4 and x8 memory devices can enable ‘Termination Data Query Strobe’, (TDQS) memory device function in a DDR3 mode register. This allows full termination resistor (Rtt) selection, as controlled by ODT, for x4 devices even when mixed with x8 devices. Terminations may be used to minimize signal reflections and improve signal margins.

In an exemplary embodiment, the memory hub device 104 allows the memory controller 110 and 310 to manipulate SDRAM clock enable (CKE) and RESET signals directly using a ‘control CKE’ command, ‘refresh’ command and ‘control RESET’ maintenance command. This avoids the use of power down and self refresh entry and exit commands. The memory controller 110 ensures that each memory configuration is properly controlled by this direct signal manipulation. The memory hub device 104 can check for various timing and mode violations and report errors in a fault isolation register (FIR) and status in a rank status register (e.g. in test and pervasive block 402).

In an exemplary embodiment, the memory hub device 104 monitors the ready status of each DDR3 SDRAM rank and uses it to check for invalid memory commands. Errors can be reported in FIR bits. The memory controller 110 also separately tracks the DDR3 ranks status in order to send valid commands. Each of the control ports (e.g. ports A and B) of the memory hub device 104 may have 0, 1, 2 or 4 ranks populated. A two-bit field for each control port (8 bits total, e.g. in command state machine 414) can indicate populated ranks in the current configuration.

Information regarding the operation of an alternate exemplary cascade interconnect buffer 104 (identified as buffer 500) is described herein, relating to FIG. 5. This figure is a block diagram similar to that of FIG. 4b, and includes a summary of the signals, signal groups and operational blocks comprising the alternate exemplary buffer or hub 104, which may be utilized on exemplary DIMMs similar to DIMMs 103a-d but including additional interconnect wiring between the buffer device 304 and memory devices 109 and 111 as described herein, such that the one or more spare memory devices 111 can be uniquely controlled to provide additional reliability and/or MTBF for systems in which this capability is desired.

FIG. 5 includes a command state machine 514 coupled to read/write (RW) data buffers 516, two DDR3 command and address physical interfaces and two DDR3 data physical interfaces with both physical interfaces supporting memory devices 109 and 111 respectively, each further connected to two ports. DDR3 command and address physical interface 508 supports memory devices 109 connected to two ports (DDR3 2xCA PHY), DDR3 command and address physical interface 509 supports spare memory devices 111 connected to two ports (DDR3 2xSP_CA PHY) 508, DDR3 data physical interface 506 supports two 9-byte ports (DDR3 2x9B Data PHY), DDR3 data physical interface 507 supports two 1-byte ports (DDR3 2x1B SP_Data PHY) 507, a data multiplexor 519, controlled by command state machine 514 to establish data communication with memory devices 109 via Data PHY 506 or spare memory devices 111 via Data PHY 507. This alternate memory buffer 104 exemplary embodiment enables the spare memory devices 111 to each be uniquely addressed and controlled, as well as to be applied to replace any 8 bit memory device 109 which is determined to be exhibiting failures in excess of a pre-determined limit. As with the memory buffer device 104 as described in FIG. 4b (400), the buffer device 104 as described in FIG. 5 is also operable in one or more of various test modes and/or diagnostic modes which may test a portion and/or all of the memory devices 109 and 111 and/or shadowing modes (e.g. when data is sent to memory devices 109 and data directed to a memory device 109 is “shadowed” with a spare memory device 111 (e.g. written to both a memory device 109 and a memory device 11)). The buffer device 104 as described in FIG. 5 further includes a memory control (MC) protocol block 512, and a memory card built-in self test engine (MCBIST) 510. The MCBIST 510 provides the extended capability to read/write different types of data patterns to specified memory locations (including, in the exemplary embodiment, memory locations within spare memory devices 111) for the purpose of detecting memory device faults that are common in memory subsystems. The command state machine 514 translates and interprets commands received from the MC protocol block 512 and the MCBIST 510 and may perform functions as previously described in reference to the controller interfaces 306 and 308 of FIG. 2 and the memory buffer interfaces of FIG. 4a. The RW data buffers 516 include circuitry to buffer read and write data under the control of command state machine 514, directing data to and/or from Data PHY 506 and/or Data PHY 507. The MC protocol block 512 interfaces to PDS Rx 424, SDS Tx 428, PUS Tx 430, and SUS Rx 434, with the functionality as previously described in FIGS. 4a and 4b. The MC protocol block 512 interfaces with the RW data buffers 516, enabling the transfer of read and write data from RW buffers 516 to one or more upstream and downstream buses connecting to Data Phy 506 and/or Data PHY 507, depending on the current operation (e.g. read and write operations initiated by memory controller 210, MCBIST 510 and/or an other buffer device 104, etc). Additionally, a test and pervasive block 402 interfaces with primary FSI clock and data (PFSI[CD][01]) and secondary (daisy chained) FSI clock and data (SFSI[CD][01]) as an embodiment of the service interface 124 of FIG. 1. In an alternate embodiment, which may included as an additional mode of operation supported by the same buffer 104, test and pervasive block 402 may be programmed to operate as a JTAG-compatible device wherein JTAG signals may be received, acted upon and/or re-driven via the test and pervasive block 402. Test and pervasive block 402 may include a FIR block 404, used for such purposes as the reporting of error information (e.g. FAULT_N).

In the alternate exemplary embodiment of buffer 104 described herein, inputs to the PDS Rx 424 include true and compliment primary downstream link signals (PDS_[PN](14:0)) and clock signals (PDSCK [PN]). Outputs of the SDS Tx 428 include true and compliment secondary downstream link signals (SDS_[PN](14:0)) and clock signals (SDSCK_[PN]). Outputs of the PUS Tx 430 include true and compliment primary upstream link signals (SUS_[PN](21:0)) and clock signals (SUSCK_[PN]). Inputs to the SUS Rx 434 include true and compliment secondary upstream link signals (PUS_[PN](21:0)) and clock signals (SUSCK_[PN]).

The DDR3 2xCA PHY 508, the DDR3 2xSP_CA PHY 509, the DDR3 2x9B Data PHY 506 and the DDR3 2x1B Data PHY 507 provide command, address and data physical interfaces for DDR3 for 2 ports of memory devices 109 and 111, wherein the data ports associated with Data PHY 506 include a 64 bit data interface and an 8 bit EDC interface and the data ports associated with Data PHY 507 include an 8 bit data and/or EDC interface (depending on the original usage of the memory device(s) 109 replaced by the spare device(s) 111—totaling 80 bits (also referred to as 9B and 1B respectively, totaling 10 available bytes)). The DDR3 2xCA PHY 508 includes memory port A and B address/command/error signals (M[AB]_[A(15:0), BA(2:0), CASN, RASN, RESETN, WEN, PAR, ERRN, EVENTN]), memory IO DQ voltage reference (VREF), memory control signals (M[AB][01]_[CSN(3:0), CKE(3:0), ODT(1:0)]) and memory clock differential signals (M[AB][01]_CLK_[PN]). The DDR3 2xCA PHY 509 includes memory port A and B address/command/error signals (M[AB]_SP[A(15:0),BA(2:0), CASN, RASN, RESETN, WEN, PAR, ERRN, EVENTN]), memory IO DQ voltage reference (SP_VREF), memory control signals (M[AB]_SP[01]_[CSN(3:0), CKE(3:0), ODT(1:0)]) and memory clock differential signals (M[AB]_SP[01]_CLK_[PN]), and memory control signals M[AB]_SP[01]_CKE(3:0). The alternate exemplary embodiment, as described herein, provides a high level of unique control of the spare memory devices 111. Other exemplary embodiments may include less unique signals to the spare memory devices 111, as a means of reducing pincount of the hub device 104, reducing the number of unique wires and the additional wiring difficulty associated with exemplary modules 103, etc, thereby retaining some signals in common between memory devices 109 and 111 for DIMMs using an alternate exemplary buffer. The DDR3 2x9B Data PHY 506 includes memory port A and B data signals (M[AB]_DQ(71:0)) and memory port A and B data query strobe differential signals (M[AB]_DQS_[PN](17:0)) and the DDR3 2x1B Data PHY 507 includes memory port A and B data signals (M_SP[AB]_DQ(7:0)) which comprise memory port A and B spare data signals, and memory port A and B data query strobe differential signals (M_SP[AB]_DQS_[PN](1:0)). Although shown as a separate block, spare bit Data PHY 507 may be included in the same block as Data PHY 506 without diverging from the teachings herein.

The alternate exemplary buffer 104 as described in FIG. 5 operates in the same manner as described in FIG. 4b, except as related to the increased flexibility and power management capability associated with the operation of spare devices 111 that may be attached to the buffer 104 as shown in FIG. 5. By including one or more of a unique Data PHY 507 and a unique DDR3 2xSP_CA PHY 509 for connection to the spare memory devices 111, increased flexibility is achieved regarding the power management and application of the spare memory devices 111. For example, depending on the number and connection of control, command and address wires to spare memory devices 111 from DDR3 2xSP_CA PHY 509, in an exemplary embodiment where each spare memory device is provided with such signals as a unique select (e.g. CSN), address (e.g. A(15:0) and BA(2:0), it will be possible to utilize any spare memory device 111 to replace any memory device 109 in any rank of the port to which the spare memory device(s) 111 are connected, as well as control the power utilized by the spare memory device(s).

Turning now to FIG. 6, an example of a memory system 600 that includes one or more host memory channels 206 and 208 are shown, wherein each may be connected to one or more cascaded memory hub devices 104, depicted in a planar configuration (e.g. wherein hub device 104 is attached to a system board, memory card or other assembly and connects to and controls one or more memory modules such as UDIMMs (Unbuffered DIMMs) and Registered DIMMs (RDIMMs). Each memory hub device 104 may include two synchronous dynamic random access memory (SDRAM) ports 605 and 606, with either port connected to zero, one or two industry-standard UDIMMs 608 and/or RDIMMs 609. For example, the UDIMMs 608 can include multiple memory devices, such as a version of double data rate (DDR) dynamic random access memory (DRAM), e.g., DDR1, DDR2, DDR3, DDR4. RDIMMs 609 can also utilize multiple memory devices, such as a version of double data rate (DDR) dynamic random access memory (DRAM), e.g., DDR1, DDR2, DDR3, DDR4, as well as include one or more register(s), PLL(s), buffer(s) and/or a device combining two or more of the register, PLL and buffer functions in addition to other functions such as non-volatile storage, voltage measurement and reporting, temperature measurement and reporting. Although the example depicted in FIG. 6 utilizes DDR3 as storage devices 109 on UDIMMs 608 and RDIMMs 609, other memory device technologies may be employed within the scope of the invention. Focusing now on memory channel 206 and the devices connected via that channel to and from memory controller 210 within host 612, channel 206 is shown to carry information to and from a memory controller 210 in host processing system 612 via buses 216 and 218. The memory channel 206 may transfer data at rates upwards of 6.4 Gigabits per second. The memory hub device 104, as previously described, translates the information received from a high-speed reduced pin count bus 216 which enables communication from the memory controller 110 and the memory hub device, as previously described, may send data over a high-speed reduced-pincount bus 218 to memory controller 110 of the host processing system 612. Information received from bus 216 is translated, in the exemplary embodiment, to lower speed, wide, bidirectional ports 605 and/or 606 to support low-cost industry standard memory, thus the memory hub device 104 and the memory controller 110 are both generically referred to as communication interface devices. The channel 206 includes downstream bus 216 and upstream link segments 218 as unidirectional buses between devices in communication over the bus channel 206. The term “downstream” indicates that the data is moving from the host processing system 612 to the memory devices of one or more of the UDIMMs 608 and the RDIMMs 609. The term “upstream” refers to data moving from the memory devices of one or more of the UDIMMs 608 and the RDIMMs 609 to the host processing system 612. The information stream coming from the host processing system 612 can include of a mixture of commands and data to be stored in the UDIMMs 608 and/or RDIMMs 609 and redundancy information, which allows for reliable transfers. Although a mixture of UDIMMs 608 and RDIMMs 609 are shown as connected to ports 605 and 606, the buffer 104 ports may connect solely to UDIMMs, may connect solely to RDIMMs, may connect to other memory types including memory devices attached to other form-factor modules such as SO-DIMMs (Small Outline DIMMs), VLP DIMMs (Very Low Profile DIMMs) and/or other memory assembly types and/or connect to memory devices attached on the same or different planar or board assembly to which the buffer device 104 is attached.

Returning to FIG. 6, the information returning to the host processing system 612 can include data retrieved from the memory devices on the UDIMMs 608 and/or RDIMMs 609, as well as redundant information for reliable transfers. Commands and data can be initiated in the host processing system 612 using processing elements known in the art, such as one or more processors 620 and cache memory 622. The memory hub device 104 can also include additional communication interfaces, for instance, a service interface 624 to initiate special test modes of operation that may assist in configuring and testing the memory hub device 104.

In an exemplary embodiment, the memory controller 110 has a very wide, high bandwidth connection to one or more processing cores of the processor 620 and cache memory 622. This enables the memory controller 210 to monitor both actual and predicted future data requests to be directed to the memory attached to the memory controller 210. Based on the current and predicted processor 620 and cache memory 622 activity, the memory controller 210 determines a sequence of commands to best utilize the attached memory resources to service the demands of the processor 620 and cache memory 622. This stream of commands is mixed together with data that is written to the memory devices of the UDIMMs 608 and/or RDIMMs 609 in units called “frames”. The memory hub device 104 interprets the frames as formatted by the memory controller 210 and translates the contents of the frames into a format compatible with the UDIMMs 608 and/or RDIMMs 609. Bus 636 includes data and data strobe signals sourced from port A of memory hub 104 and/or from memory devices 109 on UDIMMs 608. In exemplary embodiments, UDIMMs 608 would include sufficient memory devices 109 to enable the writing and reading data widths of 64 or 72 data bits, although more or less data bits may be included. When populated with 8 bit memory devices, contemporary UDIMMs would include 8, 9, 16, 18, 32 or 36 memory devices, inter-connected to form 1, 2 or 4 ranks of memory as is known in the art. Memory devices 109 on UDIMMs 608 would further receive controls, commands, addresses, clocks and may receive and/or transmit other signals such as Reset, Error, etc over bus 638.

Bus 640 includes data and data strobe signals sourced from port B of memory hub 104 and/or from memory devices 109 on RDIMMs 609. In exemplary embodiments, RDIMM s 609 would include sufficient memory devices 109 to enable the writing and reading data widths of 64, 72 or 80 data bits, although more or less data bits may be included. When populated with 8 bit memory devices, contemporary RDIMMs would include 8, 9, 10, 16, 18, 20, 32, 36 or 40 memory devices, inter-connected to form 1, 2 or 4 ranks of memory as is known in the art. Memory devices 109 on contemporary RDIMMs 609 would further receive controls, commands, addresses, clocks and may receive and/or transmit other signals such as Reset, Error, etc via one or more register device(s), buffer device(s), PLL(s) and or devices including one or more functions such as those described herein, over bus 642.

Although only a single memory channel 206 is depicted in detail in FIG. 6 connecting the memory controller 210 to a single memory device hub 104, systems produced with this configuration may include more than one discrete memory channel 206, 208, etc from the memory controller 210, with each of the memory channels 206, 208, etc operated singly (when a single channel is populated with one or more modules) or in parallel (when two or more channels are populated with one or more modules) such that the desired system functionality and/or performance is achieved for that configuration. Moreover, any number of bitlanes (e.g. single ended signal(s), differential signal(s), etc) can be included in the buses 216 and 218, where a lane is comprised of one or more bitlane segments, with a segment of a bitlane connecting a memory controller 210 to a memory buffer 104 or a buffer 104 to an other buffer 104 such that the bitlane can span multiple cascade-interconnected memory hub devices 104. For example, the downstream bus 216 can include 13 bitlanes, 2 spare bitlanes and a clock lane, while the upstream link segments 118 may include 20 bit lanes, 2 spare lanes and a clock lane. To reduce susceptibility to noise and other coupling interference, low-voltage differential-ended signaling may be used for all bit lanes of the buses 216 and 218, including one or more differential-ended forwarded clocks in an exemplary embodiment. Both the memory controller 210 and the memory hub device 104 contain numerous features designed to manage the redundant resources, which can be invoked in the event of hardware failures. For example, multiple spare lanes of the bus(es) 216 and/or 218 can be used to replace one or more failed data or clock lane(s) in the upstream and downstream directions.

In order to allow larger memory configurations than could be achieved with the pins available on a single memory hub device 104, the memory channel protocol implemented in the memory system 600 allows for the memory hub devices 104 to be cascaded together. Memory hub device 104 contains buffer elements in the downstream and upstream directions so that the flow of data can be averaged and optimized across the high-speed memory channel 206 to the host processing system 612. Flow control from the memory controller 210 in the downstream direction is handled by downstream transmission logic (DS Tx) 433, while upstream data is received by upstream receive logic (US Rx) 434 e.g. as depicted in FIG. 4b. The DS Tx 202 drives signals on the downstream bus 216 to a primary downstream receiver (PDS Rx) 424 of memory hub device 104. If the commands or data received at the PDS Rx 424 target a different memory hub device, then it is re-driven downstream via a secondary downstream transmitter (SDS Tx) 433; otherwise, the commands and data are processed locally at the targeted memory hub device 104. The memory hub device 104 may analyze the commands being re-driven to determine the amount of potential data that will be received on the upstream bus 218 for timing purposes in response to the commands. Similarly, to send responses upstream, the memory hub device 104 drives upstream communication via a primary upstream transmitter (PUS Tx) 430 which may originate locally or be re-driven from data received at a secondary upstream receiver (SUS Rx) 434.

During normal operations initiate from memory controller 210, a single memory hub device 104 simply receives commands and writes data on its primary downstream link, PDS Rx 424, via downstream bus 216 and returns read data and responses on its primary upstream link, PUS Tx 430, via upstream bus 430.

Memory hub devices 104 within a cascaded memory channel are responsible for capturing and repeating downstream frames of information received from the host processing system 112 on its primary side onto its secondary downstream drivers to the next cascaded memory hub device 104, an example of which is depicted in FIG. 2. Read data from cascaded memory hub device 104 downstream of a local memory hub device 104 are safely captured using secondary upstream receivers and merged into a local data stream to be returned safely to the host processing system 612 on the primary upstream drivers.

Memory hub devices 104 include support for a separate out-of-band service interface 624, as further depicted in FIG. 6, which can be used for advanced diagnostic and testing purposes. In an exemplary embodiment it can be configured to operate either in a double, (redundant) field replaceable unit service interface (FSI) or Joint Test Action Group (JTAG) mode. Power-on reset and initialization of the memory hub devices 104 may rely heavily on the service interface 624. In addition, each memory hub device 104 can include an inter-integrated circuit (I²C or I2C) master interface that can be controlled through the service interface 124. The I²C master enables communications to any I²C slave devices connected to I²C pins on the memory hub devices 104 through the service interface 624.

The memory hub devices 104 have a unique identity assigned to them in order to be properly addressed by the host processing system 612 and other system logic. The chip ID field can be loaded into each memory hub device 104 during its configuration phase through the service interface 624.

The exemplary memory system 600 uses cascaded clocking to send clocks between the memory controller 210 and memory hub devices 104, as well as to the memory devices of the UDIMMs 608 and RDIMMs 609. In the memory system 600, the clock is forwarded to the memory hub device 104 on downstream bus 206 as previously described. This high speed clock is received at the memory hub device 104 as forwarded differential clock 421 of FIG. 4a, which uses a phase locked loop (PLL) included in PDS PHY 424 of FIG. 4 to clean up the bus clock, which is passed to a configurable PLL (i.e., clock ratio logic) as an internal hub clock and forwarded via the SDS PHY 433 as SDSCK_PN 427 to the next downstream memory hub device 104. The output of the configurable PLL 310 is the SDRAM clock (e.g. a memory bus clock sourced from DDR3 2xCA PHY 408 of FIG. 4b) operating at a memory bus clock frequency, which is a scaled ratio of the bus clock received by the PDS PHY circuitry 424.

Commands and data values communicated on the buses comprising channel 206 may be formatted as frames and serialized for transmission at a high data rate, e.g., stepped up in data rate by a factor of 4, 5, 6, 8, etc.; thus, transmission of commands, address and data values is also generically referred to as “data” or “high-speed data” for transfers on the buses comprising channel 206 (the buses comprising channel 206 are also referred to as high-speed buses 216 and 218). In contrast, memory bus communication is also referred to as “lower-speed”, since the memory bus interfaces from ports 605 and 606 operate as a reduced ratio of the bus speed 216 and 218.

Continuing with FIG. 6, an exemplary embodiment of hub 104 as shown in FIG. 6 may include spare chip interface block 626 which connects to one or more spare memory devices 111 using control, command and address buses 628 and 632 and bi-directional data buses 630 and 634. Control, command and address buses 628 and 632 may include such conventional signals as addresses (e.g. 15:0), bank addresses (e.g. 2:0), CAS, RAS, WE, Reset, chip selects (e.g. 3:0), CKEs (e.g. 3:0), ODT(s), VREF, memory clock(s), etc, although some memory devices may include further signals such as error signals, parity signals. One or more of the signal within these buses may be bi-directional, thereby permitting information to be provided from memory device(s) 111 to hub device 104, memory controller 210 and/or sent to an external processing unit such as a service processor via service interface 624. Data buses 630 and 634 may include such conventional signals as bi-directional data (e.g. DQs 7:0 for 8 bit spare memory devices), and bi-directional strobe(s) (e.g. one or more differential DQS signals). In the exemplary embodiment shown in FIG. 6, one or more of the spare memory devices 111 may be enabled by the hub device 104 and/or the memory controller 210 to replace one or more memory devices 109 located on memory modules 608 and/or 609. By connecting the spare memory devices 111 to the hub device 104 using command, control, address, data and DQS signals that are separate from those attached to memory modules 608 and 609, the one or more spare memory devices 111 may be applied to replace one or more failing memory devices on modules 608 and/or 609, with the appropriate address, commands, data, signal timings, etc to enable replacement of any memory device in any rank of any of the module types (including modules with and without registers affecting the timing relationships and/or transfer of such signals as controls, commands, addresses. In exemplary embodiments, the one or more registers (or other devices described herein that may be included on such DIMMs) may include checking circuitry such as parity or ECC on received controls, commands and/or data and/or other circuitry that produces one or more signals that may be sent back to the hub device 104 for interpretation by the hub device 104, the memory controller 210 and/or other devices included in or independent of host system 612, such as a service processor.

As we have provided a local interface memory hub, it supports a DRAM interface that is wider then the processor channel that feeds the hub to allow for additional spare DRAM devices attached to the hub that are used as replace parts for failing DRAMs in the system. These spare DRAM devices are transparent to the memory channel in that the data from these spare devices does not ever get transferred across the memory channel they are instead used inside the memory hub. The interface between the memory hub and the memory controller retains the same data width as for modules that do not contain spare DRAMs. There is no increase in memory signal lines between the memory module and the memory controller for the spare memory devices so the overall system cost is lower. This also results in lower overall memory subsystem/system power consumption and higher useable bandwidth than having separate “spare memory” devices connected directly to memory controller. Memory subsystem may have more data bits written and/or read then sent back to controller (hub selects data to be sent back). Memory faults found during local (e.g. hub or DRAM-initiated “scrubbing”) are reported to the memory controller/processor and/or service processor at the time of identification or at a later time. If sparing is invoked on the module without processor/controller initiation, record and/or report faults such that failure(s) are logged and sparing can be replicated after re-powering (if module is not replaced).

The enhancement defined here is to move the sparing function into the memory hub. With current high end designs supporting a memory hub between the processor and the memory controller it is possible to add function to the memory hub to support additional data lanes between the memory devices and the hub without affecting the bandwidth or pin counts of the channel from the hub to the processor. These extra devices in the memory hub would be used as spare devices with the ECC logic still residing in the processor chip or memory controller. Since, in general, the memory hubs are not logic bound and are usually a technology or 2 behind the processors process technology you get to use cheaper or even free silicon for this logic function. At the same time you get to reduce the pin count on the processor interface and potentially reduce the logic in the expensive processor silicon. The logic in the hub will spare out the failing DRAM bits prior to sending the data across the memory channel so it can be effectively transparent to the memory controller in the design.

The memory hub will implement sparing circuits to support the data replacement once a failing chip is detected. The detection of the failing device can be done in the memory controller with the ECC logic detecting failing DRAM location either during normal accesses to memory or during a memory scrub cycle. Once a device is determined to be bad the memory controller will issue a request to the memory hub to switch out the failing memory device with the spare device. This can be as simple as making the switch once the failure is detected or a system may choose to first initialize the spare device with the data from the failing device prior to the switch over. In the case of the immediate switch over the spare device will have incorrect data but since the ECC code is already correcting the failing device it would also be capable of correcting the data in the spare device until it has been aged out. For a more reliable system first the hub would be directed to just set up the spare to match the failing device on write operations and the processor or the hub would then issue a series of read write operations to transfer all the data from the failing device to the new device. The preference here would be to take the read data back through the ECC code to first correct it before writing it into the spare device. Once the spare device is fully initialized the hub would be directed to then switch over the read operation to the spare device so that the failing device is no longer in use. All these operations can happen transparently to any user activity on the system so it appears that the memory never failed.

Note that in the above description the memory controller is used to determine that there is a failure in a DRAM that needs to be spared out. It is also possible that the hub could manage this on its own depending on how the system design is set up. The hub could monitor the scrubbing traffic on the channel and detect the failure itself, it is also possible that the the hub could itself issue the scrubbing operations to detect the failures. If the design allows the hub to manage this on its own then it would become fully transparent to the memory controller and to the channel. Either of these methods will work at a system level.

Depending on the reliability requirements of the system the DIMM design can add 1 or multiple spare chips to bring the fail rate of the DIMM down to meet the system level requirements without affecting the design of the memory channel or the processor interface.

Our buffered DIMM with one or more spare chips on the DIMM has the data bits sourced from the spare chips which are connected to the memory hub device and the bus to the DIMM includes only those data bits used for normal operation.

This provides a memory subsystem including x memory devices which have y data bits which may be accessed in parallel, the memory devices comprising normally accessed memory devices and a spare memory device, wherein the normally accessed memory devices comprise a data width of z where y is greater than z. The DIMM subsystem further including a hub device with circuitry to redirect one or more bits from the normally accessed memory devices to one or more bits of a spare memory device while maintaining the original interface data width of z.

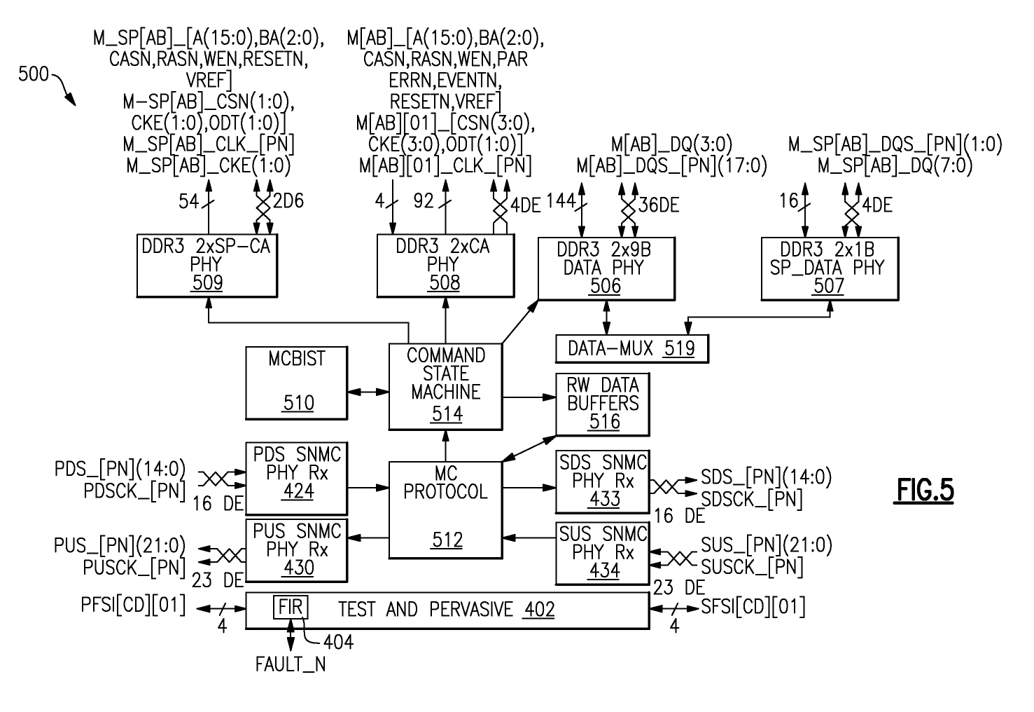

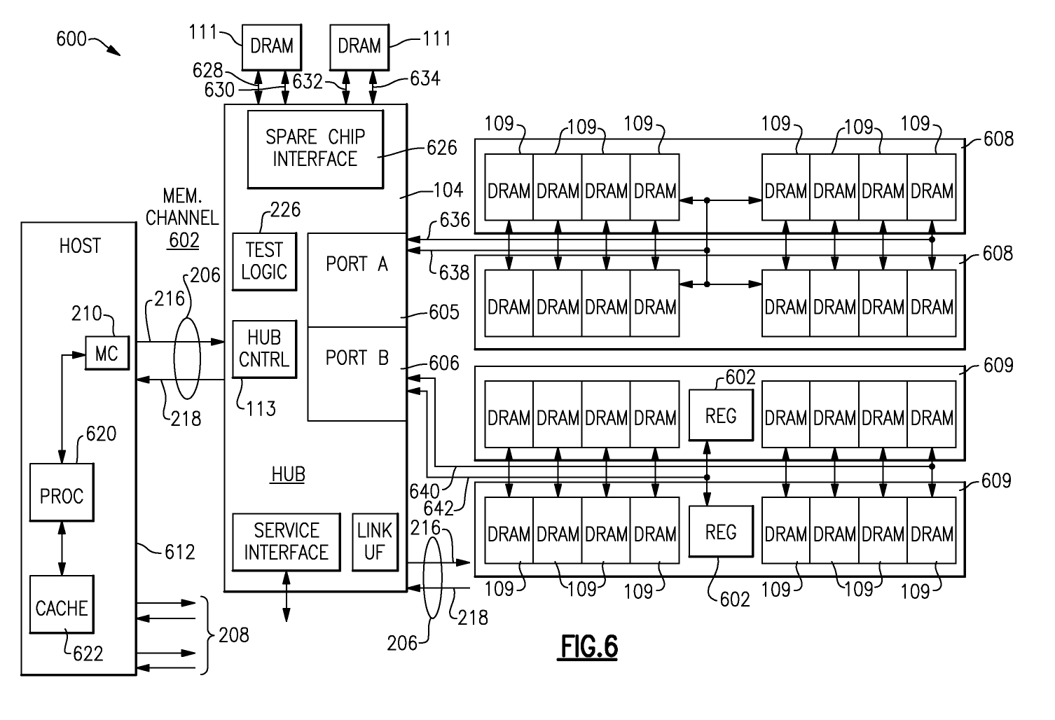

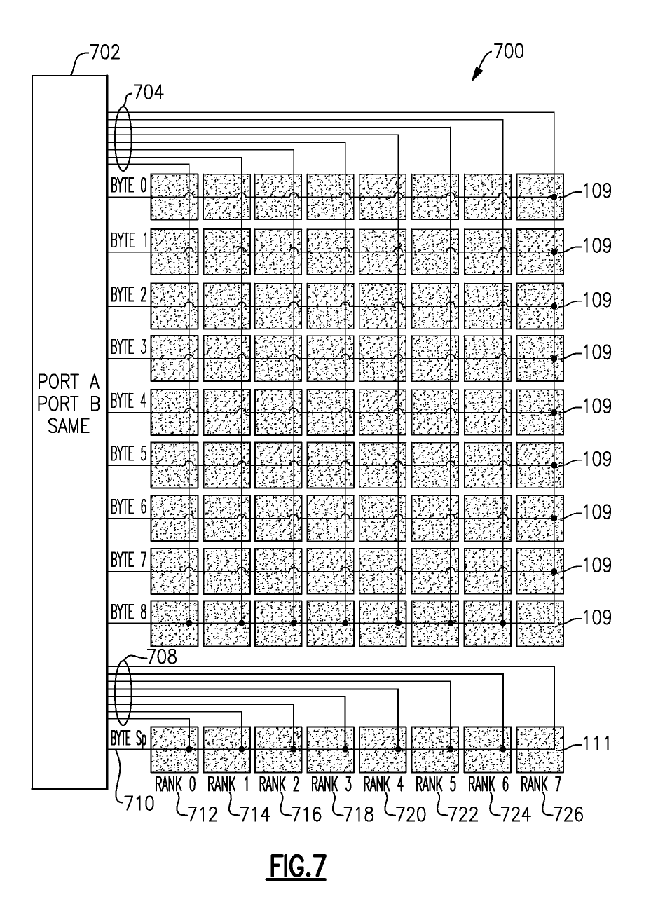

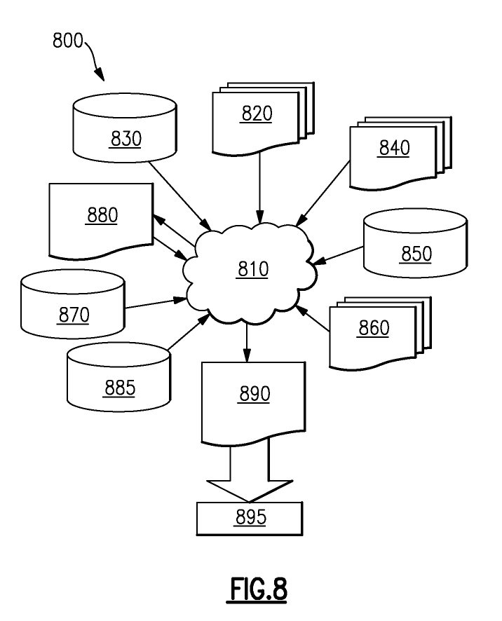

Turning now to FIG. 7, an exemplary interconnection structure for data (DQ), data strobes (DQSs), and CKEs between buffer or hub device 104 and memory devices 109 and 111. The exemplary buffer 104 includes a tenth byte lane on each of its memory data ports. In an exemplary embodiment, the tenth byte lanes are used as locally selectable spare bytes on DIMMs equipped with the required extra SDRAMs (e.g. spare memory devices 111). The spare data signals are named: M[AB]SP_DQ(7:0), and their strobes are named: M[AB]SP_DQS_[PN](1:0). The spare memory devices 111 can be either 4 bit (e.g. x4) or 8 bit (e.g. x8) width devices, but in the exemplary embodiment, the spare memory devices 111 are always selected in byte lane granularity. In exemplary embodiments such as that described in FIG. 4b wherein a single spare memory device is included for each memory rank, each rank, on each data port 605 and 606, can have a uniquely selected spare memory device 111. The exemplary buffer device 104 will dynamically switch between configured spare bytes lanes as each rank of DIMM 103a-d is accessed. The spare data byte lane feature can also be applied to contemporary industry standard UDIMMs, RDIMMs, etc when an exemplary buffer device such as that described in FIG. 6 is utilized in conjunction with such DIMMs. Locally selectable spares memory devices (e.g. memory devices connected to exemplary buffer devices 104 which include memory spare interface circuitry) have an advantage over spare memory devices selected by and/or attached to memory controller 210, in that they do not require additional memory channel lanes to transport the spare information from and to the memory controller. The disadvantage of the added complexity in the buffer device logic, pincount, etc, minimized and/or removed by the reduction in memory controller and/or host processor interface pincounts, the cost of such spare memory devices and/or hub devices being incurred as memory size is increased rather than incurred on the base system. The exemplary solution allows customers to determine the desired memory reliability and MTBF, without incurring penalties should this improved reliability and MTBF not be desired.

Continuing with FIG. 7, exemplary buffer device 104 also includes dedicated clock enable control signals 708 for each spare SDRAM rank. The CKE signals are named M[AB][01]SP_CKE(3:0). Dedicated CKE controls spare memory devices 111 not being utilized to replace a failing memory device 109 to be left in a low power mode such as self refresh mode for most of the run-time operation of the memory system. In an exemplary embodiment, when any spare memory device 111 is enabled on a data port (e.g. port 605 or port 606) to replace a failing memory device 111 within a memory rank (e.g. one of memory ranks such as memory rank 0 (712), the CKE connecting to the spare memory device 111 now being used to replace the failing memory device 109 will begin shadowing the primary CKE (e.g. the CKE within CKE signals 704 that is associated with the rank which includes the failing memory device 109) the next time the SDRAMs connected to said port exit the SR mode. In this way, no additional channel (e.g. 206 and/or 208) commands are needed to manipulate the CKEs 708 connected to spare memory devices 111. In the exemplary embodiment, the buffer device 104 either places unused spare memory devices 111 into the low power mode (e.g. self refresh mode) for most of the memory system run-time operation, or shadows the primary CKE connected to a memory rank when one or more spare memory devices 111 are enabled to replace one or more failing memory devices 109 within said memory rank.

In an exemplary embodiment, it is important to note that invoking one or more spare memory device(s) 111 to replace one or more failing memory device(s) 109 connected to a memory buffer port may not immediately cause the CKE(s) associated with the one or more memory spare device(s) 111 to mimic the primary CKE signal polarity and operation (e.g. “value)”. In an exemplary embodiment such as that summarized herein, the CKE(s) connected to the one or more spare memory devices 111 the port may remain at a low level (e.g. a “0”) until the spare memory devices 111 exit the low power mode (e.g. self refresh mode). The exiting from the low power mode could result from a command sourced from the memory controller 210, result from the completion of a maintenance command such as ZQCAL, result from another command initiated and/or received by buffer device 104.

The following information is intended to further clarify the memory device “sparing” operation in an exemplary embodiment. A single configuration bit is used to indicate to hub devices 104 that the memory subsystem in which the hub device 104 is installed supports the 10^{th} byte which comprises the spare data lanes connecting to the spare memory devices 111. If the memory system does not support the operation and use of spare memory device(s), the configuration bit is set to indicate that the spare memory device operation is disabled, and hub device(s) 104 within the memory system to which spare memory devices 111 are connected will reduce power to the spare memory device(s) in a manner such as previously described (e.g. initiating and/or processing commands which include such signals as the CKE signal(s) connected to the spare memory device(s) 111). In addition, hub device circuitry associated with the spare memory device 111 operation may be depowered and/or placed in a low power state to further reduce overall memory system power. Each exemplary memory rank (e.g. 8 exemplary memory rank 712, 714, 716, 718, 720, 722, 724 and 726) are attached to port A 605 of memory buffer 140, with each rank including nine memory devices 109 and one spare memory device 111. For exemplary buffer 104 having two memory ports, each connected to 8 memory ranks, a total of sixteen ranks may be connected to the hub device. Other exemplary hub devices may support more or less memory ranks and/or have more or less ports than that described in the exemplary embodiment described herein. Continuing on, exemplary buffer device 104 connecting to the memory devices 109 and 111 as shown in FIG. 7 includes a four bit configuration field (e.g. included in command state machine such as 414 in FIG. 4b) indicating which, if any, data lane (e.g. an 8 bit (x8) memory device 109 connected to one of the byte lanes 706, further connected to one of the 8 CKE signals 704) comprising one byte of data should be “shadowed” by the spare byte lane. When instructed to do so based on a command from command state machine 414, data mux 419 will store any write data to both the primary data byte (e.g. the byte comprising the failing memory device 109) and the spare data byte (e.g. the spare memory device 111 replacing the failing memory device 109). When in a low power state (e.g. self refresh), the write data will be ignored by the affected spare memory device(s) 111 until the affected spare memory device(s) 111 exit the low power state—e.g. during the next exit self refresh command. The buffer device 104 also includes a one bit field for enabling the read data path to each rank of spare memory devices (e.g. attached to a spare data byte lane 710). When the one bit field is set, the read data for the associated spare memory device 111 (e.g. a spare memory device 111 as shown in FIG. 7 as being associated with one of 8 ranks 712 to 726) will be returned to the memory channel. A similar method is used for accesses resulting from an MCBIST operation. In an exemplary embodiment, write data will no longer be stored to the failing memory device in the primary data byte—e.g. to reduce the memory system power utilization.

In an exemplary embodiment, systems that support the 10^{th} spare data byte lane (e.g. the byte lane 710 comprising the spare memory device(s) 111) should set the previously mentioned spare memory device configuration bit and configure each spare rank to shadow the write data on one pre-determined byte lane. In an exemplary embodiment, this byte is byte 0 (included in 706) for both memory data ports. During an exemplary power-on-reset operation, the memory controller, service processor or other processing device and/or circuitry will instruct the memory buffer device(s) 104 to comprising the memory system to perform all power-on reset operations to both the memory devices 109 and the spare memory devices 111—e.g. including basic and advanced DDR3 interface initialization. When POR (power-in-reset) is complete and the memory devices 109 and 111 are in a known state, such as in self-refresh mode, system control software (e.g. in host 612) will interrogate its non-volatile storage and determine which spare memory devices 111, if any, have previously been deployed. The system control software then uses this information to configure each buffer device 104 to enable operation of spare memory device(s) in communication with the buffer device that have been previously deployed by the buffer device 104. In the exemplary embodiment, spare memory device(s) 111 that have not previously been deployed will remain in SR mode during most of run-time operation.

Periodic memory device interface calibration may be required by such memory devices as DDR3, DDR4. In an exemplary embodiment, during the periodic memory interface calibration (e.g. DDR3 interface calibration) the buffer and/or hub device 104 is responsible for the calibration of both the primary byte lanes 706 and spare byte lanes (e.g. one or more spare byte lanes 710 connected to the buffer device). In this way the spare byte lanes 710 are always ready to be invoked (e.g. by system control software) without the need for a special initialization sequence. When the periodic calibration maintenance commands, (e.g. commands MEMCAL and ZQCAL) have completed, the buffer device(s) 104 will return spare ranks on ports with no spares (e.g. spare memory device(s) 111) invoked to the SR (self-refresh) mode. The spares will stay in SR mode until at least one spare memory device 111 attached to the port is invoked or until the next periodic memory device interface calibration. If a spare memory device 111 was recently invoked but is still in self refresh mode (such as previously described), the CKE associated with the spare memory device changes state (other signals may participate in the power state change of the spare memory device), causing the spare memory device 111 to exit self refresh. In an exemplary embodiment, commands are issued at the outset of the periodic memory interface calibration which cause the spare CKEs to begin shadowing the primary CKEs and enabling the interfaces to spare memory devices 111 to be calibrated. When spare memory devices are invoked, in order to simplify the loading of spare memory device(s) 111 with correct data, a staged invocation is employed. In an exemplary embodiment, the write path to an invoked spare memory device is selected causing the spare memory device 111 to shadow the write information being sent to memory device 109 that is to be replaced. In alternate exemplary embodiments, data previously written to the memory device 109 to be replaced is read, with correction means applied to the data being read (e.g. by means of EDC circuitry in such devices as the memory buffer and the memory controller, using available EDC check bits for each address), with the corrected data written to the spare memory device that has been invoked. This process is completed for the complete range of addresses for the memory device 109 being replaced, after which the read data path is re-directed for the memory device 109 being replaced, using data mux 419, such that memory reads to the rank including the memory device now replaced include data from spare memory device 111 in lieu of the data from memory device 109 which has been replaced by spare memory device 111.

Other exemplary means of a memory device 109 with a spare memory device 111 may be employed which also include the copying of data from the replaced memory device 109 to the invoked memory device 111 including the shadowing of writes from the failing memory device 109 to the spare memory device 111 until many or all memory addresses for the failing memory device have been written. Other exemplary means may be used including the continued reading of data from the failing memory device 109, with write operations shadowed to the spare memory device 111 and read data corrected by available correction means such as EDC, completing a memory “scrub” operation as is known in the art, the halting of memory accesses to the memory rank including the failing memory device until most or all memory data has been copied (with or without first correcting the data) from failing memory device 109 to spare memory device 111, etc, depending on the memory system and/or host processing system implementation. The writing of data to a spare memory device 111 from a failing memory device 111 may be done in parallel with normal write and read operations to the memory system, since read data will continue to be returned from the selected memory devices, and in exemplary embodiments, the read data will include EDC check bits to permit the correction of any data being read which includes faults.

When a spare memory device 111 has been loaded with the corrected data from the primary memory device 109, it is safe to enable the read data path (e.g. in data PHY 406). In the exemplary embodiment there is no need to quiet the target port during the write and/or read data port configuration is modified in regard to the failing memory device 109 and/or the spare memory device 111.

An example of an exemplary system control software method and procedure associated with the invocation of a spare memory device 111 follows:

1) A failing memory device 109 is marked by the memory controller 210 error correcting logic. The ‘mark verify’ procedure is executed and if the mark is needed the procedure continues.

2) System control software writes the write data path configuration register located in the command state machine 414 of the memory buffer device 104 which is in communication with the failing memory device 109. This also links the spare CKE (e.g. as included in spare CKE signal group 708 of FIG. 7) to the primary CKE—in the exemplary embodiment the linkage of the primary CKE to the spare CKE does not take effect until the next enter “SR all” operation.

3a) The memory controller sends a command to the affected buffer device to cause the memory devices included in one or more ranks attached to the memory port including the failing memory device 109 to enter self refresh. In the exemplary embodiment, the write data to the failing memory device(s) is then shadowed to the spare memory device(s) 111. The self refresh entry command must be scheduled such that it does not violate any memory device 109 timing and/or functional specifications. Once done and without violating any memory device 109 timings and/or functional specifications, the affected memory devices can be removed from self refresh. or

3b) The memory controller or other control means waits until there is a ZQCAL or MEMCAL operation, which will also initiate a self refresh operation, enable the spare CKEs 708 and shadow the memory write data currently directed to the failing memory device(s) to the spare memory device(s) 111.

At this point, the spare memory device(s) is now online, with the memory write ports properly configured to enable the spare memory devices, now being invoked, to be prepared for use.

4) The memory controller and/or other control means initiates a memory ‘scrub clean up’ (e.g. a special scrub operation where every address is written. In exemplary embodiments, even those memory addresses having no error(s) are included in the memory “scrub” operation).

5) The read path is then enabled to the spare memory device(s) 111 on the memory buffer(s) 104 for those memory device(s) 109 being replaced by spare memory device(s) 111. Data is no longer read from the failing memory device(s) 109 (e.g. even if read, the data read from the failing memory device(s) 109 is not transferred from the buffer device 104 to memory controller 210).

6) The ‘verify mark’ procedure is run again. The mark should no longer be needed as the spare memory device(s) invoked should result in valid data being read from the memory system and/or reduce the number of invalid data reads to a count that is within pre-defined system limits.

7) If operation #6 is clean, the mark is removed and normal memory operation resumes.

The spare memory devices 111 may be tested with no additional test patterns and/or without the addition of signals between the memory controller 210 and memory hub device(s) 104. The exemplary hub device 210 supports the direct comparison of data read from the one or more spare memory device(s) 111 to one or more predetermined byte(s) data. In the exemplary embodiment the data written to and read from the byte 0 of one or more memory ports (including all memory ranks attached to the respective ports) is compared to the memory data written to and read from the spare memory device(s) 111 comprising a byte width, although another primary byte may be used instead of byte 0. In alternate embodiments having two or more spare memory device 111 bytes of data width and/or multiple spare memory devices 111 which can be used in place of one or more bytes of data width, two or more bytes comprising the primary data width may be used as a comparison means. In exemplary memory DIMMs and/or memory assemblies including one or more spare memory devices the same primary byte(s) should be selected as during the POR sequence previously described. The exemplary memory buffer 104 writes data to both the predetermined byte lane(s) and to the spare memory device byte lanes (e.g. “shadows” data from one byte to another) and continuously compares the data read from the spare memory device(s) to the predetermined byte lane's read data. If a mismatch is ever detected, a FIR bit will be set, identifying error information. This FIR bit should be used by system control software to determine that the spare memory device(s) (which may comprise one or more bytes) always return the same read data as the primary memory devices to which the read data is being compared (which may also comprise an equivalent one or more bytes of data width and having equivalent memory address depth) during the one or more test FIR bits associated with the one or more spare memory device(s) 111. The memory tests should then be performed, comparing primary memory data to spare memory data as described.

When complete, system control software should query the FIR bit(s) associated with all memory buffer devices 104 and all memory data ports and ranks to determine the validity of the memory data returned by the one or more spare memory devices 111. When complete, the FIR bits should be masked and/or reset for the rest of the run-time operation.

In the exemplary embodiment, when spare byte lane write and read paths are invoked they are also available for testing by the memory buffer 104 MCBIST logic (e.g. 410). By providing test capability of the one or more spare memory devices 111, further diagnosis of failing spare memory devices 111 may be locally tested by the exemplary memory buffer device 104—e.g. in the event that a mis-compare is detected using the previously described comparison method and technique.

In order to help identify failing SDRAM devices, the exemplary memory buffer device(s) report errors detected during calibrations and other operations by means of the FIR (fault isolation register), with a byte lane granularity. These errors may be detected during at such times as initial POR operation, during periodic re-calibration, during MCBIST testing, during normal operation when data shadowing is invoked.

So, generally we have described a DIMM subsystem includes a communication interface register and/or hub device in addition to one or more memory devices. The memory register and/or hub device continuously or periodically checks the state of the spare memory device(s) to verify that it is functioning properly and is available to replace a failing memory device. The memory register and/or hub device selects data bits from another memory device in the subsystem and writes these bits to the spare memory device to initialize the memory array device to a known state. In an exemplary embodiment, the memory hub device will check the state of the spare memory device(s) periodically or during each read access to one or more a specific address(es) directed to the device containing the data which is also now contained in the spare memory device such that the data is “shadowed” into the spare device, by reading both the device containing the data and the spare memory device to verify the integrity of the spare memory device. The hub device and/or the memory controller determines, if the data read between the device containing the data and spare memory device is not the same, whether the original or spare memory device contains the error. In an exemplary embodiment, the checking of the normal and spare device may be completed via one or more of several means, including complement/re-complement, memory diagnostic writes and read of different data to each device.

The implementation of the memory subsystem containing a local communication interface hub device, memory device(s) and one or more spare device(s) allows the hub device and/or the memory controller to transparently monitor the state of the spare memory device(s) to verify that it is still functioning properly.

This monitoring process provides for run time checking of a spare DRAM on a DIMM transparently to the normal operation of the memory subsystem. In a high end memory subsystem it is normal practice for the memory controller to periodically read every location in memory to check for errors. This procedure is generally called scrubbing of memory and is used for early detection of a memory failure so that the failing device can be repaired before if degrades enough to actually result in a system crash. The issues with the spare DRAMs are that the data bits from this DRAM do not get transferred back to the processor where they can be checked. Because of this the spare device may sit in the machine for many months without being checked and when it is needed for a repair action, the system does not know if the device is good or if it is bad. Switching to the spare device if it is bad could place the system in a worse state then it was prior to the repair action. This invention allows the memory hub on the DIMM to continuously or periodically check the state of the spare DRAM to verify that it is functioning properly.

To check the DRAM the hub has to be able to know what data is in the device and it needs to be able to check this data. To initialize the spare device to a known state the memory hub will select the data bits from another DRAM on the DIMM and during every write cycle it will write these bits into the memory device to initialize the device to a known state. The hub may choose the data bits from any DRAM device within the memory rank for this procedure. To check the state of the spare DRAM, every time the rank of memory is read that contains the DRAM that is being shadowed into the spare, the spare will also be read. The data from these two devices must always be the same; if they are different then one of the two devices has failed. At this point it is unknown if the spare device is failing or the mainstream device is failing but in any case the failure is logged. If the number of detected failures goes over the threshold then an error status bit will be sent to the memory controller to let it know that there has been an error detected with a spare device on the DIMM. At this point it is up to the memory controller to determine if the failure is the mainstream device or the spare device and it can simply determine this by checking its status of the mainstream device. If the memory controller is showing no failures on the mainstream device then the spare has failed. If the memory controller is showing failures on the mainstream device it still must decide if the spare is good in the unlikely case that they both have failed. To do this the memory controller will issue a command to the memory hub to move the shadow DRAM for the spare to a different DRAM on the DIMM. Then it will initialize and check the spare by issuing a read write operation to all locations in the device. At this point the memory controller will scrub the rank of memory to check the state of the spare. If there are no failures then the spare is good and can be used as a replacement for a failing DRAM.

The above procedure can run continuously on the system and monitor all spare devices in the system to maintain the reliability of the sparing function. However if the system chooses to power off the spare devices but still wants to periodically check the spare chip it will have to periodically power up the spare device, map it to a device in the rank and initialize the data state in the device by running read write operation to all locations in the address range of he memory rank. This read write operation will read the data from each location in the mapped device and write it into the spare device. This operation can by run in the background so that it does not affect system performance or it can be given priority to the memory and quickly initialize the spare. Once the spare is initialized a normal scrub pass through the memory rank will be executed with the memory hub checking the spare against the mapped device. Once completed the status register in the memory hub will be checked to look for errors and if there are none then the spare device is operating correctly and may be placed back in its low power state until it is either needed as a replacement or needs to be checked again.

We have provided for buffered memory subsystem with a common spare memory device that can be employed to correct one or more fails in any of two or more memory ranks on the memory assembly.

With the buffered DIMM with one or more spare chips on the DIMM, the data bits sourced from the spare chips are connected to the memory hub device and the bus to the DIMM includes only those data bits used for normal operation. Also, this buffered DIMM with one or more spare chips on the DIMM has spare devices which are is shared among all the ranks on the DIMM and this reduces the fail rate on the DIMM.

The memory hub device includes separate control bus(es) for the spare memory device to allow the spare memory device(s) to be utilized to replace one or more failing bits and/or devices within any rank of memory in the memory subsystem. In an exemplary embodiment, the separate control bus from the hub to the spare memory device includes one or more of a separate and programmable CS (chip select), CKE (clock enable) and other other signal(s) which allow for unique selection and/or power management of the spare device.

The memory hub chip that supports a seperate and independent DRAM interface that contains common spare memory devices that can be used by the processor to replace a failing DRAM in any of the ranks attached to that memory hub. These spare DRAM devices are transparent to the memory channel in that the data from these spare devices does not ever get transferred across the memory channel they are instead used inside the memory hub. The interface between the memory hub and the memory controller retains the same data width as for modules that do not contain spare DRAMs. There is no increase in memory signal lines between the memory module and the memory controller for the spare memory devices so the overall system cost is lower. This also results in lower overall memory subsystem/system power consumption and higher useable bandwidth than having separate “spare memory” devices for each rank of memory connected directly to memory controller. Memory subsystem may have more data bits written and/or read then sent back to controller (hub selects data to be sent back). Memory faults found during local (e.g. hub or DRAM-initiated “scrubbing”) are reported to the memory controller/processor and/or service processor at the time of identification or at a later time. If sparing is invoked on the module without processor/controller initiation, record and/or report faults such that failure(s) are logged and sparing can be replicated after re-powering (if module is not replaced).

The enhancement defined here is to move the sparing function from the processor/memory controller into the memory hub. With current high end designs supporting a memory hub between the processor and the memory controller it is possible to add function to the memory hub to support additional data lanes between the memory devices and the hub without affecting the bandwidth or pin counts of the channel from the hub to the processor. These extra devices in the memory hub would be used as spare devices with the ECC logic still residing in the processor chip or memory controller. Since, in general, the memory hubs are not logic bound and are usually a technology or 2 behind the processors process technology you get to use cheaper or even free silicon for this logic function. At the same time you get to reduce the pin count on the processor interface and potentially reduce the logic in the expensive processor silicon. The logic in the hub will spare out the failing DRAM bits prior to sending the data across the memory channel so it can be effectively transparent to the memory controller in the design.

The memory hub will implement a independent data bus(es) to access the spare devices. The number of spare devices depends on how many spares are needed to support the system fail rate requirements so this number could be 1 or more spare for all the memory on the memory hub. This invention allows a single spare DRAM to be used for multiple memory ranks on a buffered DIMM. This allows a lower cost implementation of the sparing function vs common industry standard designs that have a spare for every rank of memory. By moving all the spare devices to a independent spare bus off the hub chip the design also improves the reliability of the DIMM by allowing multiple spares to be used for a single rank. For example with the common sparing designs there is a single spare for each rank of memory. So for a 4 rank DIMM there would be 4 spares on the DIMM, with one spare dedicated to each rank of memory. With this design a 4 rank DIMM could still have 4 spare devices but the spare devices are floating and each spare is available for any rank so if there were 2 failing DRAMs in a single rank this invention would allow 2 of the spares to be used to repair the DIMM where the common sparing design would not be able to repair the DIMM since there is only one spare that can be used on any given rank.

The memory hub will implement sparing logic to support the data replacement once a failing chip is detected. The detection of the failing device can be done in the memory controller with the ECC logic detecting failing DRAM location either during normal accesses to memory or during a memory scrub cycle. Once a device is determined to be bad the memory controller will issue a request to the memory hub to switch out the failing memory device with the spare device. This can be as simple as making the switch once the failure is detected or a system may choose to first initialize the spare device with the data from the failing device prior to the switch over. In the case of the immediate switch over the spare device will have incorrect data but since the ECC code is already correcting the failing device it would also be capable of correcting the data in the spare device until it has been aged out. For a more reliable system first the hub would be directed to just set up the spare to match the failing device on write operations and the processor or the hub would then issue a series of read write operations to transfer all the data from the failing device to the new device. The preference here would be to take the read data back through the ECC code to first correct it before writing it into the spare device. Once the spare device is fully initialized the hub would be directed to then switch over the read operation to the spare device so that the failing device is no longer in use. All these operations can happen transparently to any user activity on the system so it appears that the memory never failed.

Note that in the above description the memory controller is used to determine that there is a failure in a DRAM that needs to be spared out. It is also possible that the hub could manage this on its own depending on how the system design is set up. The hub could monitor the scrubbing traffic on the channel and detect the failure itself, it is also possible that the the hub could itself issue the scrubbing operations to detect the failures. If the design allows the hub to manage this on its own then it would become fully transparent to the memory controller and to the channel. Either of these methods will work at a system level.

Depending on the reliability requirements of the system the DIMM design can add 1 or multiple spare chips to bring the fail rate of the DIMM down to meet the system level requirements without affecting the design of the memory channel or the processor interface.

The memory subsystem contains spare memory devices which are placed in a low power state until used by the system. The memory hub chip that supports a DRAM interface that is wider than the processor channel that feeds the hub to allow for additional spare DRAM devices attached to the hub that are used as replace parts for failing DRAMs in the system. These spare DRAM devices are transparent to the memory channel in that the data from these spare devices does not ever get transferred across the memory channel they are instead used inside the memory hub as spare devices to. The interface between the memory hub and the memory controller retains the same data width as for modules that do not contain spare DRAMs. There is no increase in memory signal lines between the memory module and the memory controller for the spare memory devices so the overall system cost is lower. These spare devices are placed in a low power state, as defined by the memory architecture, and are left in this low power state until another memory device on the memory hub fails. These spare devices are managed in this low power state independently of the rest of the memory devices attached to the memory hub. When a memory device failure on the hub is detected the spare device will be brought out of its low power state and initialized to a correct operating state and then used to replace the failing device. The advantage of this invention is that the power of these spare memory devices is reduced to a absolute minimum amount until they are actually needed in the system thereby reducing overall average system power.

This also results in lower overall memory subsystem/system power consumption and higher useable bandwidth than having separate “spare memory” devices connected directly to memory controller. Memory subsystem may have more data bits written and/or read then sent back to controller (hub selects data to be sent back). Memory faults found during local (e.g. hub or DRAM-initiated “scrubbing”) are reported to the memory controller/processor and/or service processor at the time of identification or at a later time. If sparing is invoked on the module without processor/controller initiation, record and/or report faults such that failure(s) are logged and sparing can be replicated after re-powering (if module is not replaced).

As a result of the design an operation can be performed to eliminate the majority of the power associated with the spare device until it is determined that the device is required in the system to replace a failing DRAM. Since a memory spare device is attached to a memory hub actions to limit the power exposure due to the spare device are isolated from the computer system processor and memory controller with the memory hub device controlling the spare device to manage its power.

To manage the power of the spare device the memory hub will do one of the following:

1: It will place the spare devices in a reset state. As, for example, DDR3 memory devices can be employed in the system and the hub will source a unique reset pin to the spare DRAMs that can be used to place the spare DRAM in a reset state until it is needed for a repair action. This state is a low power state or reset state for the DRAM and will result in lower power at a DIMM level by turning off the spare DRAMs. The hub may choose to individually control each spare on the DIMM separately or all of the spares together depending on the configuration of the DIMM. To activate the spare the memory controller will issue a command to the memory hub indicating that the spare chip is required and at this time the memory hub will turn off the reset signal to the spare DRAM/s and initialize the spare DRAM's to place them in a operational state. Thus set of signals, with one placing the device in a low power state or low power-state programming mode and one returning the device to normal operation or normal mode from the low power state, enables insertion of a spare memory device into the rank without changing the power load.

2. The memory hub will place the spare DRAM, once the DIMM is initialized, into either a self timed refresh state or another low power state defined by the DRAM device. This will lower the power of the spare devices until they are needed by the memory controller to replace a failing DRAM device. To place just the spare DRAM devices in a low power state the memory hub will source the unique signals that are required by the DRAM device to place it into the low power state.

In addition to placing the spare DRAM into a low power state the memory hub will also power gate its drivers and receiver logic and another associated logic in the hub chip associated with the spare device to further lower the power consumed on the DIMM. The memory hub may also power gate the spare devices by controlling the power supplied to the device, where this is possible the spare device will be effectively removed from the system and draw no power until the power domain is reactivated.

The memory subsystem with one or more spare chips improves the reliability of the subsystem in a system wherein the one or more spare chips can be placed in a reset state until invoked, thereby reducing overall memory subsystem power, and spare memory can be placed in self refresh and/or another low power state until required to reduce power.

This memory subsystem including one or more spare memory devices will thus only utilize the power of a memory subsystem without the one or more spare memory devices, as the power of the memory subsystem is the same before and after the spare devices being utilized to replace a failing memory device.

FIG. 8 shows a block diagram of an exemplary design flow 800 used for example, in semiconductor IC logic design, simulation, test, layout, and manufacture. Design flow 800 includes processes and mechanisms for processing design structures or devices to generate logically or otherwise functionally equivalent representations of the design structures and/or devices described above and shown in FIGS. 1-7. The design structures processed and/or generated by design flow 800 may be encoded on machine readable transmission or storage media to include data and/or instructions that when executed or otherwise processed on a data processing system generate a logically, structurally, mechanically, or otherwise functionally equivalent representation of hardware components, circuits, devices, or systems. Design flow 800 may vary depending on the type of representation being designed. For example, a design flow 800 for building an application specific IC (ASIC) may differ from a design flow 800 for designing a standard component or from a design flow 800 for instantiating the design into a programmable array, for example a programmable gate array (PGA) or a field programmable gate array (FPGA) offered by Altera® Inc. or Xilinx® Inc.

FIG. 8 illustrates multiple such design structures including an input design structure 820 that is preferably processed by a design process 810. Design structure 820 may be a logical simulation design structure generated and processed by design process 810 to produce a logically equivalent functional representation of a hardware device. Design structure 820 may also or alternatively comprise data and/or program instructions that when processed by design process 810, generate a functional representation of the physical structure of a hardware device. Whether representing functional and/or structural design features, design structure 820 may be generated using electronic computer-aided design (ECAD) such as implemented by a core developer/designer. When encoded on a machine-readable data transmission, gate array, or storage medium, design structure 820 may be accessed and processed by one or more hardware and/or software modules within design process 810 to simulate or otherwise functionally represent an electronic component, circuit, electronic or logic module, apparatus, device, or system such as those shown in FIGS. 1-7. As such, design structure 820 may comprise files or other data structures including human and/or machine-readable source code, compiled structures, and computer-executable code structures that when processed by a design or simulation data processing system, functionally simulate or otherwise represent circuits or other levels of hardware logic design. Such data structures may include hardware-description language (HDL) design entities or other data structures conforming to and/or compatible with lower-level HDL design languages such as Verilog and VHDL, and/or higher level design languages such as C or C++.

Design process 810 preferably employs and incorporates hardware and/or software modules for synthesizing, translating, or otherwise processing a design/simulation functional equivalent of the components, circuits, devices, or logic structures shown in FIGS. 1-7 to generate a netlist 880 which may contain design structures such as design structure 820. Netlist 880 may comprise, for example, compiled or otherwise processed data structures representing a list of wires, discrete components, logic gates, control circuits, I/O devices, models. that describes the connections to other elements and circuits in an integrated circuit design. Netlist 880 may be synthesized using an iterative process in which netlist 880 is resynthesized one or more times depending on design specifications and parameters for the device. As with other design structure types described herein, netlist 880 may be recorded on a machine-readable data storage medium or programmed into a programmable gate array. The medium may be a non-volatile storage medium such as a magnetic or optical disk drive, a programmable gate array, a compact flash, or other flash memory. Additionally, or in the alternative, the medium may be a system or cache memory, buffer space, or electrically or optically conductive devices and materials on which data packets may be transmitted and intermediately stored via the Internet, or other networking suitable means.

Design process 810 may include hardware and software modules for processing a variety of input data structure types including netlist 880. Such data structure types may reside, for example, within library elements 830 and include a set of commonly used elements, circuits, and devices, including models, layouts, and symbolic representations, for a given manufacturing technology (e.g., different technology nodes, 32 nm, 45 nm, 90 nm, etc.). The data structure types may further include design specifications 840, characterization data 850, verification data 860, design rules 870, and test data files 885 which may include input test patterns, output test results, and other testing information. Design process 810 may further include, for example, standard mechanical design processes such as stress analysis, thermal analysis, mechanical event simulation, process simulation for operations such as casting, molding, and die press forming. One of ordinary skill in the art of mechanical design can appreciate the extent of possible mechanical design tools and applications used in design process 810 without deviating from the scope and spirit of the invention. Design process 810 may also include modules for performing standard circuit design processes such as timing analysis, verification, design rule checking, place and route operations.

Design process 810 employs and incorporates logic and physical design tools such as HDL compilers and simulation model build tools to process design structure 820 together with some or all of the depicted supporting data structures along with any additional mechanical design or data (if applicable), to generate a second design structure 890. Design structure 890 resides on a storage medium or programmable gate array in a data format used for the exchange of data of mechanical devices and structures (e.g. information stored in a IGES, DXF, Parasolid XT, JT, DRG, or any other suitable format for storing or rendering such mechanical design structures). Similar to design structure 820, design structure 890 preferably comprises one or more files, data structures, or other computer-encoded data or instructions that reside on transmission or data storage media and that when processed by an ECAD system generate a logically or otherwise functionally equivalent form of one or more of the embodiments of the invention shown in FIGS. 1-7. In one embodiment, design structure 890 may comprise a compiled, executable HDL simulation model that functionally simulates the devices shown in FIGS. 1-7.

Design structure 890 may also employ a data format used for the exchange of layout data of integrated circuits and/or symbolic data format (e.g. information stored in a GDSII (GDS2), GL1, OASIS, map files, or any other suitable format for storing such design data structures). Design structure 890 may comprise information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure as described above and shown in FIGS. 1-7. Design structure 890 may then proceed to a stage 895 where, for example, design structure 890: proceeds to tape-out, is released to manufacturing, is released to a mask house, is sent to another design house, is sent back to the customer.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

Aspects of the capabilities of the present invention can be implemented in software, firmware, hardware or some combination thereof.

As will be appreciated by one skilled in the art, the present invention may be embodied as a system, method or computer program product. Accordingly, certain aspects of the present invention may take the form of an entirely hardware embodiment specified as hardware, an entirely software embodiment (including firmware, resident software, micro-code) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

The features are compatible with memory controller pincounts which are increasing to achieve desired system performance, density and reliability targets, with these pincounts, especially in designs wherein the memory controller is included on the same device or carrier as the processor(s), have before become problematic given available packaging and wiring technologies in addition to production costs associated with the increasing memory interface pincounts. The systems employed can provide high reliability systems such as computer servers, as well as other computing systems such as high-performance computers which utilize Error Detection and Correction (EDC) circuitry and information (e.g. “EDC check bits”) with the check bits stored and retrieved with the corresponding data such that the retrieved data can be verified as valid, and if not found to be valid, a portion of the detected fails (depending on the strength of the EDC algorithm and the number of EDC check bits) corrected—thereby enabling continued operation of the system when one or more memory devices in the memory system are not fully functional. Memory subsystems can be provided (e.g. memory modules such as those provided by the Dual Inline Memory Modules (DIMMs), memory cards, etc) include memory storage devices for both data and EDC information, with the memory controller often including pins to communicate with one or more memory channels—with each channel connecting to one or more memory subsystems which may be operated in parallel to comprise a wide data interface and/or be operated singly and/or independently to permit communication with the memory subsystem including the memory devices storing the data and EDC information.

Any combination of one or more computer usable or computer readable medium(s) may be utilized for the software code aspects of the invention. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF before being stored in the computer readable medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Technical effects include the enablement and/or facilitation of test, initial bring-up, characterization and/or validation of a memory subsystem designed for use in a high-speed, high-reliability memory system. Test features may be integrated in a memory hub device capable of interfacing with a variety of memory devices that are directly attached to the hub device and/or included on one or more memory subsystems including UDIMMs and RDIMMs, with or without further buffering and/or registering of signals between the memory hub device and the memory devices. The test features reduce the time required for checking out and debugging the memory subsystem and in some cases, may provide the only known currently viable method for debugging intermittent and/or complex faults. Furthermore, the test features enable use of slower test equipment and provide for the checkout of system components without requiring all system elements to be present.

The diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. Moreover, the use of the terms first, second, etc. do not denote any order or importance, but rather the terms first, second, etc. are used to distinguish one element from another.

What is claimed is:

1. A computer memory system, comprising a memory controller, one or more memory bus channel(s), a local memory interface device for a memory subsystem which is coupled to one of said memory bus channels to communicate with devices of a memory array over said memory bus channel for normal memory operations.

2. The computer memory system according to claim 1 wherein said local interface device is a buffered hub located on a memory module.

3. The computer memory system according to claim 1 wherein said memory subsystem is a DIMM provided with one or more spare memory devices on the DIMM, and data bits sourced from the spare memory devices are connection to a buffered hub and the memory bus channel.

4. The computer memory system according to claim 1 wherein said memory subsystem has said local memory interface located on a memory module subsystem, and the memory module subsystem is provided with one or more spare devices, and data bits sourced from said spare devices are connected to said local memory interface and a memory bus channel to said memory module from said memory controller includes only those data bits used for normal operation.

5. The computer memory system according to claim 3 where one or more spare memory devices are located on said DIMM and shared among all ranks on the DIMM.

6. The computer memory system according to claim 3 where said local memory interface has one or more separate control buses for said spare device and said spare memory is coupled to replace one or more failing bits and/or memory devices within any rank of memory in the memory subsystem.

7. The computer memory system according to claim 6 wherein said separate control busses utilize separate and programmable CS (chip select) and CKE (clock enable signals for unique selection and power management of spare devices.

8. The computer system according to claim 1 wherein said local memory interface and said memory controller are coupled to enable transparent monitoring of the state of a spare device to verify that it is functioning properly after it is employed as a spare.

9. The computer system according to claim 1 wherein there are provided x memory devices which may be accessed in parallel including those which are normally accessed and those provided for spare memory, wherein for the x memory devices there are y data bits which may be accessed, and wherein those for normally accessed memory have a data width of z and the number of y data bits is greater than the data width of z, said subsystem local memory interface having a circuit to enable the local memory interface to redirect one or more bits from the normally accessed memory devices to one or more bits of a spare memory device while maintaining the original interface data width of z.

10. The computer system according to claim 1 wherein one or more spare chips are placed in a reset state for low power until invoked, thereby reducing overall memory subsystem power.

11. The computer system according to claim 1 wherein spare chips are placed in a self refresh or another low power state until required to be invoked to reduce power.

12. The computer system according to claim 1 wherein power to the memory subsystem is the same before and after spare devices are invoked for utilization to replace a failing memory and wherein even with the use of spare memory devices the memory utilizes only power levels of the memory subsystem used before any spare memory devices are invoked.

13. The computer system according to claim 1 wherein said memory devices are employed for the storing and retrieval of data and ECC information.

14. The computer system according to claim 1 wherein the local memory interface provides circuits to change the operating state, utilization of power and wherein the width of the memory controller interface is not increased to accommodate any spare memory devices, whether or not the memory controller interface is buffered or unbuffered by said local memory interface.

15. A memory system comprising a memory controller and memory module(s) including at least one local communication interface hub device(s), a rank of memory device(s) and spare memory device(s) which communicate by way of said hub device(s) which are cascade-interconnected.

16. A memory of operation of plurality of memory modules each having a rank of memory devices and a memory controller, comprising the steps of processing storage and retrieval requests for data and EDC check bits for addresses of memory devices, said rank including one or more additional memory devices which have the same data width and addressing as the memory devices, and using said additional memory devices as a spare memory device by a local memory interface to replace a failing memory device, wherein the memory interface between the modules and memory controller transfers read and write data in groups of bits, over one or more transfers, to selected memory devices, and using said a spare memory device as replace a replacement for a failing memory device, the data is written to both the original and failing memory device as well as to its spare device which has been activated by said local memory interface to replace the failing memory device, and during read operations, the exemplary memory interface device reads data from memory devices in addition to the spare memory device and replaces the data from failing memory device, with the data from the spare memory device which has been activated by the memory interface device to provide the data originally intended to be read from failing memory device.

17. A memory system comprising a memory controller and memory module(s) including at least one local communication interface hub device(s), a rank of memory device(s) and spare memory device(s) which communicate by way of said hub device(s) which are connected to each other and the memory controller using multi-drop bus(es).

18. A memory of operation of plurality of memory modules each having a rank of memory devices and a memory controller, comprising the steps of processing storage and retrieval requests for data and EDC check bits for addresses of memory devices, said rank including one or more additional memory devices which have the same data width and addressing as the memory devices, and using said additional memory devices as a spare memory device by a local memory interface to replace a failing memory device, wherein the memory interface between the modules and memory controller transfers read and write data in groups of bits, over one or more transfers, to selected memory devices, and using said a spare memory device as replace a replacement for a failing memory device, the data is written to both the original and failing memory device as well as to its spare device which has been activated by said local memory interface to replace the failing memory device, said memory module being coupled to a multi-drop bus memory system that includes a memory bus which includes a bi-directional data bus and a bus used to transfer address, command and control information from memory controller to one or more memory modules wherein data and address buses respectively connect said memory controller to one or more memory modules in a multi-drop nature without re-driving signals from one memory modules to another memory module or to said memory controller, said local memory device including a buffer device which re-drives data, address, command and control information associated with accesses to memory and said memory modules include trace lengths to the buffer of said memory interface device, such that a short stub length exists at each memory module position.

19. A memory of operation of plurality of memory modules of a memory subsystem having a rank of memory devices and a memory controller, comprising the steps of passing read and write information over a memory interface device located on a memory subsystem to communicate with the memory device(s) of the memory module, and sourcing and storing data bits of a spare memory device coupled to said memory interface device and to a memory channel connected to the memory module over which data bits used for normal operations pass, said spare memory device sharing all of the ranks on the memory module and utilized to replace one or more failing bits and/or devices within any rank of memory in the memory subsystem, said channel to the memory module passing control command signals over said memory interface device to said memory devices and the spare memory for power management of the spare memory.

20. The method according to claim 19 wherein said memory module is monitored to detect failing bits and/or devices and upon detection of a failure the spare memory is invoked and activated from a reset state of power to a normal powered on state for a memory device and one or more bits from the normally accessed memory devices are redirected to one or more bits of a spare memory device while maintaining the original interface data width with the power of the memory subsystem being the same before and after the spare devices are utilized to replace a failing memory device.
